(19) United States
(12) Patent Application Publication
(10) Pub. No.: US 2026/0095884 A1
(43) Pub. Date: Apr. 2, 2026

(54) Methods for Aggregating Resources for Positioning Measurements

(71) Applicant: Telefonaktiebolaget LM Ericsson (publ), Stockholm (SE)

(72) Inventors: Deep Shrestha, Linköping (SE); Florent Munier, Västra Frölunda (SE); Siva Muruganathan, Stittsville (CA); Muhammad Ali Kazmi, Sundbyberg (SE)

(21) Appl. No.: 19/115,031

(22) PCT Filed: Sep. 29, 2023
(86) PCT No.: PCT/EP2023/077022

§ 371 Date: Mar. 25, 2025

Related U.S. Application Data
(60) Provisional application No. 63/412,085, filed on Sep. 30, 2022.

(51) Int. Cl. H04W 64/00

(52) U.S. Cl. CPC H04W 64/00

(57) ABSTRACT

Embodiments include methods for a user equipment (UE) configured for positioning in a radio access network (RAN). Such methods include receiving, from a positioning node, a configuration of a plurality of positioning reference signal (PRS) resources. Each PRS resource is associated with one of a plurality of different carrier frequencies or positioning frequency layers (PFLs) transmitted by a RAN node. The configuration includes one or more aggregation identifiers indicating one or more relationships between the plurality of carrier frequencies or PFLs. Such methods include selectively performing positioning measurements jointly and/or coherently on PRS resources associated with two or more of the carrier frequencies or PFLs, based on one or more of the following: the one or more aggregation identifiers, and an arrangement of the UE's plurality of receiver (Rx) chains. Such methods include sending to the positioning node a report including the positioning measurements.

### TECHNICAL FIELD

The present disclosure relates generally to wireless communication networks, and more specifically to configuring and performing positioning measurements by nodes of a wireless network for the purpose of determining the geographic location of a user equipment (UE).

### BACKGROUND

Currently the fifth generation (5G) of cellular systems, also referred to as New Radio (NR), is being standardized within the Third-Generation Partnership Project (3GPP). 5G/NR is developed for maximum flexibility to support multiple and substantially different use cases. These include enhanced mobile broadband (eMBB), machine type communications (MTC), ultra-reliable low latency communications (URLLC), side-link device-to-device (D2D), and several other use cases.

FIG. 1 illustrates a high-level view of an exemplary 5G network architecture, consisting of a Next Generation Radio Access Network (NG-RAN, 199) and a 5G Core (5GC, 198). The NG-RAN can include one or more gNodeB's (gNBs) connected to the 5GC via one or more NG interfaces, such as gNBs (100, 150) connected via respective interfaces (102, 152). More specifically, the gNBs can be connected to one or more Access and Mobility Management Functions (AMFs) in the 5GC via respective NG-C interfaces and to one or more User Plane Functions (UPFs) in 5GC via respective NG-U interfaces. The 5GC can include various other network functions (NFs), such as Session Management Function(s) (SMF).

The NG-RAN is layered into a Radio Network Layer (RNL) and a Transport Network Layer (TNL). The NG-RAN architecture, i.e., the NG-RAN logical nodes and interfaces between them, is defined as part of the RNL. For each NG-RAN interface (NG, Xn, F1) the related TNL protocol and the functionality are specified. The TNL provides services for user plane transport and signaling transport.

NG RAN logical nodes (e.g., gNB 100) include a Central Unit (CU or gNB-CU, e.g., 110) and one or more Distributed Units (DU or gNB-DU, e.g., 120, 130). CUs are logical nodes that host higher-layer protocols and perform various gNB functions such controlling the operation of DUs. DUs are decentralized logical nodes that host lower layer protocols and can include, depending on the functional split option, various subsets of the gNB functions. Each CU and DU can include various circuitry needed to perform their respective functions, including processing circuitry, communication interface circuitry (e.g., transceivers), and power supply circuitry.

A gNB-CU connects to one or more gNB-DUs over respective F1 logical interfaces (e.g., 122 and 132 shown in FIG. 1). However, a gNB-DU can be connected to only a single gNB-CU. The gNB-CU and its connected gNB-DU(s) are only visible to other gNBs and the 5GC as a gNB. In other words, the F1 interface is not visible beyond gNB-CU.

5G/NR technology shares many similarities with fourth generation (4G) Long-Term Evolution (LTE) technology. For example, NR uses CP-OFDM (Cyclic Prefix Orthogonal Frequency Division Multiplexing) in the DL and both CP-OFDM and DFT-spread OFDM (DFT-S-OFDM) in the UL. As another example, in the time domain, NR DL and UL physical resources are organized into equal-sized 1-ms subframes. A subframe is further divided into multiple slots of equal duration, with each slot including multiple OFDM-based symbols.

In addition to providing coverage via cells as in LTE, NR networks also provide coverage via “beams.” In general, a downlink (DL, i.e., network to UE) “beam” is a coverage area of a network-transmitted reference signal (RS) that may be measured or monitored by a UE. In NR, for example, RS can include any of the following: synchronization signal/PBCH block (SSB), channel state information RS (CSI-RS), tertiary reference signals (or any other sync signal), positioning RS (PRS), demodulation RS (DMRS), phase-tracking reference signals (PTRS), etc.

3GPP standards provide various ways for positioning (e.g., determining the position of, locating, and/or determining the location of) UEs operating in NR networks. In general, a positioning node configures a target device (e.g., UE) and/or radio network nodes (RNN, e.g., gNB, ng-eNB, or RNN dedicated for positioning measurements) to perform one or more positioning measurements according to one or more positioning methods. For example, the positioning measurements can include timing (and/or timing difference) measurements on UE, network, and/or satellite transmissions. The positioning measurements are used by the target device, the measuring node, and/or the positioning node to determine the target device's location.

### SUMMARY

NR UEs can perform positioning measurements on DL PRS transmitted by gNBs/TRPs, based on PRS configurations provided to the UE by the gNB and/or a positioning node. 3GPP Rel-17 supports PRS configuration in multiple frequency carriers/positioning frequency layers (PFLs), but does not support aggregation of resources from different carriers/PFLs to form wider-bandwidth PRS, which can improve accuracy and/or precision of positioning measurements (e.g., timing/ranging measurements). Furthermore, each of the multiple carriers/PFLs may have a slightly different timing error/offset than the others, which must be accounted for to achieve the improved accuracy and/or precision due to aggregation. Solutions to these problems, issues, and/or difficulties are needed.

An object of embodiments of the present disclosure is to improve positioning of UEs in a RAN, such as by providing, enabling, and/or facilitating solutions to overcome exemplary problems summarized above and described in more detail below.

Some embodiments include methods (e.g., procedures) for a UE configured for positioning in a RAN.

These exemplary methods include receiving, from a positioning node, a configuration of a plurality of PRS resources. Each PRS resource is associated with one of a plurality of different carrier frequencies or positioning frequency layers (PFLs) transmitted by a RAN node. The configuration includes one or more aggregation identifiers indicating one or more relationships between the plurality of carrier frequencies or PFLs.

These exemplary methods also include selectively performing positioning measurements jointly and/or coherently on PRS resources associated with two or more of the carrier frequencies or PFLs, based on one or more of the following: the one or more aggregation identifiers, and an arrangement of the UE's plurality of receiver (Rx) chains. These exemplary methods also include sending to the positioning node a report including the positioning measurements.

In some of these embodiments, each of the aggregation identifiers is associated with one or more of the PRS resources, and determining which of the plurality of PRS resources can be aggregated includes the following operations, for each PRS resource:
determining that the PRS resource can be aggregated with other PRS resources associated with the same aggregation identifier as the PRS resource; and
determining that the PRS resource cannot be aggregated with other PRS resources associated with different aggregation identifiers than the PRS resource.

In some of these embodiments, the UE's plurality of Rx chains are arranged into a plurality of Rx timing error groups (TEGs) or Rx phase coherence error groups (PEGs). In some variants of these embodiments, determining which of the plurality of PRS resources can be aggregated for joint and/or coherent positioning measurements is further based on which of the plurality of carrier frequencies or PFLs can be received by one of the following: a single Rx chain, or multiple Rx chains that are in a single Rx TEG or Rx PEG.

In some variants of these embodiments, performing positioning measurements jointly and/or coherently on the PRS resources associated with the two or more different carrier frequencies or PFLs includes receiving the two or more different carrier frequencies or PFLs using one of the following: a single Rx chain, or multiple Rx chains that are in a single Rx TEG or Rx PEG.

In some variants of these embodiments, for each positioning measurement, the report includes an identifier of an Rx TEG or a Rx PEG associated with the Rx chain used to perform the positioning measurement.

In some embodiments, these exemplary methods also include receiving, from the RAN node, an association or mapping between the plurality of carrier frequencies or PFLs and one or more of the following used by the RAN node to transmit the PRS: a plurality of transmitter (Tx) chains, and a plurality of antenna ports.

Other embodiments include methods (e.g., procedures) for a positioning node configured to operate with a RAN.

These exemplary methods include sending, to a UE having a plurality of receiver (Rx) chains, a configuration of a plurality of PRS resources. Each PRS resource is associated with one of a plurality of different carrier frequencies or PFLs transmitted by a RAN node. The configuration includes one or more aggregation identifiers indicating one or more relationships between the plurality of carrier frequencies or PFLs. These exemplary methods also include receiving from the UE a report including positioning measurements performed by the UE, using the plurality of Rx chains, on PRS resources associated with two or more of the carrier frequencies or PFLs.

In some embodiments, the UE's plurality of Rx chains are arranged into a plurality of Rx timing error groups (TEGs) or Rx phase coherence error groups (PEGs). For each positioning measurement, the report includes an identifier of an Rx TEG or an Rx PEG associated with a UE Rx chain used to perform the positioning measurement.

In some of these embodiments, the received positioning measurements include positioning measurements performed jointly and/or coherently on PRS resources associated with two or more different carrier frequencies or PFLs, using one of the following: a single UE Rx chain, or multiple UE Rx chains in a single Rx TEG or Rx PEG.

In other of these embodiments, the received positioning measurements include positioning measurements performed individually and/or separately on PRS resources associated with two or more different carrier frequencies or PFLs.

In some embodiments, these exemplary methods can also include receiving from the RAN node a configuration of PRS resources in which PRS are transmitted by the RAN node. The received configuration includes the one or more aggregation identifiers.

In some of these embodiments, the plurality of carrier frequencies or PFLs are transmitted using a plurality of transmitter (Tx) chains, with each of the plurality of Tx chains transmitting at least one of the carrier frequencies or PFLs. Also, the plurality of Tx chains are arranged in a plurality of Tx TEGs or Tx PEGs, with each Tx PEG or Tx TEG including a plurality of Tx chains. Additionally, each aggregation identifier indicates two or more of the carrier frequencies or PFLs transmitted by one of the following: a single Tx chain, or multiple Tx chains in a single Tx PEG or Tx TEG.

In some embodiments, these exemplary methods can also include receiving from the RAN node an association or mapping between the plurality of carrier frequencies or PFLs and one or more of the following used by the RAN node to transmit the PRS: a plurality of Tx chains, and a plurality of antenna ports.

Other embodiments include methods (e.g., procedures) for a RAN node configured to support positioning of UEs in the RAN.

These exemplary methods include sending, to a positioning node, a configuration of a plurality of PRS resources in which PRS are transmitted by the RAN node. Each PRS resource is associated with one of a plurality of different carrier frequencies or PFLs. The configuration includes one or more aggregation identifiers indicating one or more relationships between the plurality of carrier frequencies or PFLs. These exemplary methods also include transmitting PRS in one or more cells according to the configuration. The plurality of carrier frequencies or PFLs are transmitted using a plurality of transmitter (Tx) chains, with each of the plurality of Tx chains transmitting at least one of the carrier frequencies or PFLs.

In some embodiments, the plurality of Tx chains are arranged in a plurality of Tx timing error groups (TEGs) or Tx phase coherence error groups (PEGs), with each Tx PEG or Tx TEG including a plurality of Tx chains. In some of these embodiments, each aggregation identifier indicates two or more of the carrier frequencies or PFLs transmitted by one of the following: a single Tx chain, or multiple Tx chains in a single Tx PEG or Tx TEG.

In some embodiments, transmitting PRS in one or more cells in accordance with the configuration includes transmitting in PRS resources associated with two or more different carrier frequencies or PFLs indicated by one of the aggregation identifiers, using one of the following: a single Tx chain, or multiple Tx chains that are phase coherent.

In some embodiments, these exemplary methods can also include sending, to the positioning node and/or to a UE, an association or mapping between the plurality of carrier frequencies or PFLs and one or more of the following used by the RAN node to transmit the PRS: the plurality of Tx chains, and a plurality of antenna ports.

In certain variants of any of the embodiments summarized above, the plurality of PRS resources are arranged into one or more PRS resource sets, with each PRS resource set including one or more PRS resources. Also, each aggregation identifier is associated with a corresponding one of the following: PRS resource, or PRS resource set.

Other embodiments include UEs (e.g., wireless devices, etc.), RAN nodes (e.g., base stations, eNBs, gNBs, ng-eNBs, TRPs, etc.), and positioning nodes (e.g., LMFs, E-SMLCs, SLPs, etc.) configured to perform operations corresponding to any of the exemplary methods described herein. Other embodiments include non-transitory, computer-readable media storing program instructions that, when executed by processing circuitry, configure such UEs, RAN nodes, or positioning nodes to perform operations corresponding to any of the exemplary methods described herein.

These and other embodiments described herein can facilitate UE bandwidth aggregation (e.g., multiple carriers/PFLs) for positioning measurements and network knowledge of such UE bandwidth aggregation, thereby enabling the use of bandwidth-aggregated positioning measurements to increase accuracy and/or precision with which UEs can be positioned in a wireless network.

These and other objects, features, and advantages of embodiments of the present disclosure will become apparent upon reading the following Detailed Description in view of the Drawings briefly described below.

### BRIEF DESCRIPTION OF THE DRAWINGS

FIGS. 1-2 illustrate two high-level views of an exemplary 5G/NR network architecture.

FIG. 3 shows an exemplary configuration of NR user plane (UP) and control plane (CP) protocol stacks.

FIG. 4 is a block diagram illustrating a high-level architecture for UE positioning in NR networks.

FIG. 5 shows an ASN.1 data structure for an exemplary NR-DL-PRS-Info information element (IE), according to some embodiments of the present disclosure.

FIG. 6 shows an ASN.1 data structure for an exemplary NR-DL-PRS-AssistanceData IE, according to other embodiments of the present disclosure.

FIG. 7 shows an ASN.1 data structure for another exemplary NR-DL-PRS-Info IE, according to other embodiments of the present disclosure.

FIG. 8 shows a flow diagram of a procedure for selective bandwidth aggregation for positioning measurements, according to some embodiments of the present disclosure.

FIG. 9 shows a flow diagram of another procedure for selective bandwidth aggregation for positioning measurements, according to other embodiments of the present disclosure.

FIG. 10 shows a flow diagram of an exemplary method (e.g., procedure) for a UE, according to various exemplary embodiments of the present disclosure.

FIG. 11 shows a flow diagram of an exemplary method (e.g., procedure) for a positioning node (e.g., LMF, E-SMLC, etc.), according to various embodiments of the present disclosure.

FIG. 12 shows a flow diagram of an exemplary method (e.g., procedure) for a RAN node (e.g., gNB, TRP, etc.), according to various embodiments of the present disclosure.

FIG. 13 shows a communication system according to various embodiments of the present disclosure.

FIG. 14 shows a UE according to various embodiments of the present disclosure.

FIG. 15 shows a network node according to various embodiments of the present disclosure.

FIG. 16 shows host computing system according to various embodiments of the present disclosure.

FIG. 17 is a block diagram of a virtualization environment in which functions implemented by some embodiments of the present disclosure may be virtualized.

FIG. 18 illustrates communication between a host computing system, a network node, and a UE via multiple connections, at least one of which is wireless, according to various embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided as examples to convey the scope of the subject matter to those skilled in the art.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods and/or procedures disclosed herein do not have to be performed in the exact order disclosed, unless a step is explicitly described as following or preceding another step and/or where it is implicit that a step must follow or precede another step. Any feature of any of the embodiments disclosed herein can be applied to any other embodiment, wherever appropriate. Likewise, any advantage of any of the embodiments can apply to any other embodiments, and vice versa. Other objects, features, and advantages of the enclosed embodiments will be apparent from the following description.

Furthermore, the following terms are used throughout the description given below:
Radio Access Node: As used herein, a “radio access node” (or equivalently “radio network node,” “radio access network node,” or “RAN node”) can be any node in a radio access network (RAN) that operates to wirelessly transmit and/or receive signals. Some examples of a radio access node include, but are not limited to, a base station (e.g., gNB in a 3GPP 5G/NR network or an enhanced or eNB in a 3GPP LTE network), base station distributed components (e.g., CU and DU), a high-power or macro base station, a low-power base station (e.g., micro, pico, femto, or home base station, or the like), an integrated access backhaul (IAB) node, a transmission point (TP), a transmission reception point (TRP), a remote radio unit (RRU or RRH), and a relay node.
Core Network Node: As used herein, a “core network node” is any type of node in a core network. Some examples of a core network node include, e.g., a Mobility Management Entity (MME), a serving gateway (SGW), a PDN Gateway (P-GW), a Policy and Charging Rules Function (PCRF), an access and mobility management function (AMF), a session management function (SMF), a user plane function (UPF), a Charging Function (CHF), a Policy Control Function (PCF), an Authentication Server Function (AUSF), a location management function (LMF), or the like.
Wireless Device: As used herein, a “wireless device” (or “WD” for short) is any type of device that is capable, configured, arranged and/or operable to communicate wirelessly with network nodes and/or other wireless devices. Communicating wirelessly can involve transmitting and/or receiving wireless signals using electromagnetic waves, radio waves, infrared waves, and/or other types of signals suitable for conveying information through air. Unless otherwise noted, the term “wireless device” is used interchangeably herein with the term “user equipment” (or “UE” for short), with both of these terms having a different meaning than the term “network node”.
Radio Node: As used herein, a “radio node” can be either a “radio access node” (or equivalent term) or a “wireless device.”
Network Node: As used herein, a “network node” is any node that is either part of the radio access network (e.g., a radio access node or equivalent term) or of the core network (e.g., a core network node discussed above) of a cellular communications network. Functionally, a network node is equipment capable, configured, arranged, and/or operable to communicate directly or indirectly with a wireless device and/or with other network nodes or equipment in the cellular communications network, to enable and/or provide wireless access to the wireless device, and/or to perform other functions (e.g., administration) in the cellular communications network.
Base station: As used herein, a “base station” may comprise a physical or a logical node transmitting or controlling the transmission of radio signals, e.g., eNB, gNB, ng-eNB, en-gNB, centralized unit (CU)/distributed unit (DU), transmitting radio network node, transmission point (TP), transmission reception point (TRP), remote radio head (RRH), remote radio unit (RRU), Distributed Antenna System (DAS), relay, etc.
Node: As used herein, the term “node” (without prefix) can be any type of node that can in or with a wireless network (including RAN and/or core network), including a radio access node (or equivalent term), core network node, or wireless device. However, the term “node” may be limited to a particular type (e.g., radio access node, IAB node) based on its specific characteristics in any given context.
Positioning measurements: As used herein, “positioning measurements” may include timing measurements (e.g., time difference of arrival, TDOA, RSTD, time of arrival, TOA, Rx-Tx, RTT, etc.), power-based measurements (e.g., RSRP, RSRQ, SINR, etc.), identifier detection/measurement (e.g., cell ID, beam ID, etc.), and/or any other relevant measurements that are configured for a positioning method (e.g., OTDOA, E-CID, etc.). UE positioning measurements may be reported to a network node or may be used for positioning purposes by the UE.

The above definitions are not meant to be exclusive. In other words, various ones of the above terms may be explained and/or described elsewhere in the present disclosure using the same or similar terminology. Nevertheless, to the extent that such other explanations and/or descriptions conflict with the above definitions, the above definitions should control.

The description herein focuses on a 3GPP cellular communication system and, as such, 3GPP terminology or terminology similar to 3GPP terminology is often used. However, the concepts disclosed herein are not limited to a 3GPP system and can be applied to any communication system that may benefit from them. Furthermore, although the term “cell” is used herein, it should be understood that (particularly with respect to 5G NR) beams may be used instead of cells and, as such, concepts described herein apply equally to cells and beams.

FIG. 2 shows another high-level view of an exemplary 5G network architecture, including an NG-RAN (299) and a 5GC (298). The NG-RAN can include gNBs (e.g., 210a,b) and ng-eNBs (e.g., 220a,b) that are interconnected via respective Xn interfaces. The gNBs and ng-eNBs are also connected via NG interfaces to the 5GC, more specifically to the Access and Mobility Management Functions (AMFs, e.g., 230a,b) via respective NG-C interfaces and to the User Plane Functions (UPFs, e.g., 240a,b) via respective NG-U interfaces. Moreover, the AMFs can communicate with one or more policy control functions (PCFs, e.g., 250a,b) and network exposure functions (NEFs, e.g., NEFs 260a,b).

Each of the gNBs can support the NR radio interface including frequency division duplexing (FDD), time division duplexing (TDD), or a combination thereof. Each of ng-eNBs can support the LTE radio interface. Unlike conventional LTE eNBs, however, ng-eNBs 220 connect to the 5GC via the NG interface. Each of the gNBs and ng-eNBs can serve a geographic coverage area including one more cells (e.g., 211a-b, 221a-b). Depending on the cell in which it is located, a UE (205) can communicate with the gNB or ng-eNB serving that cell via the NR or LTE radio interface, respectively. Although FIG. 2 shows gNBs and ng-eNBs separately, it is also possible that a single NG-RAN node provides both LTE and NR radio interfaces.

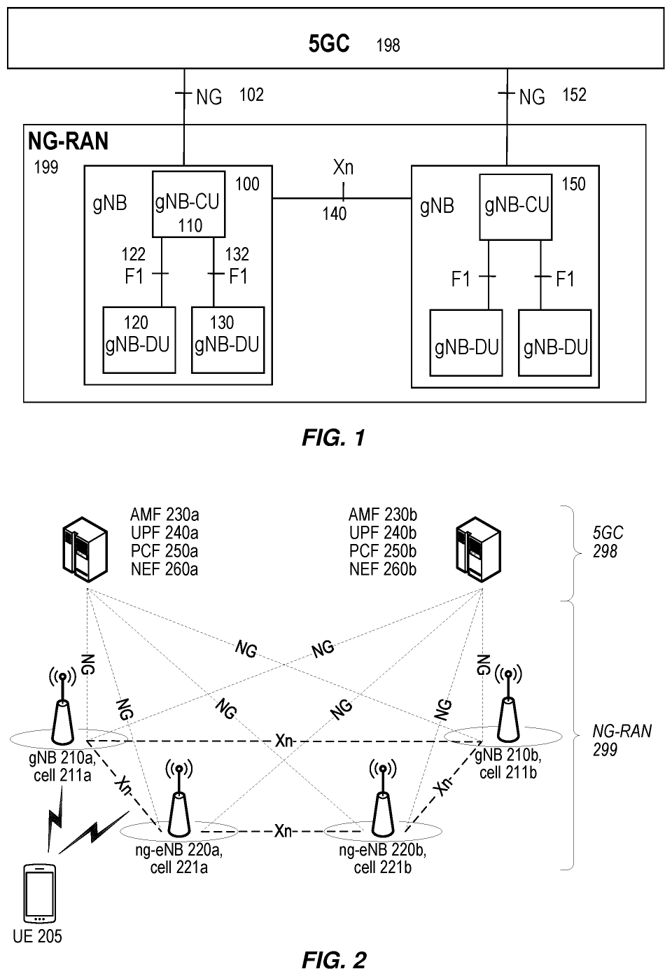

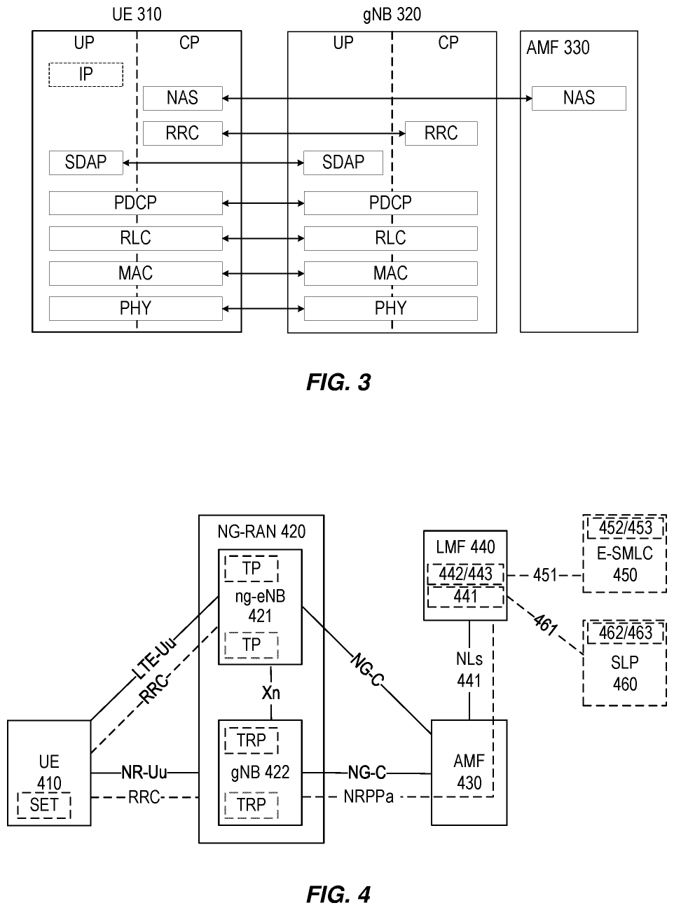

Positioning-related information, such as assistance data and positioning measurements, can be communicated between network and UE via user plane (UP) and control plane (CP). FIG. 3 shows an exemplary configuration of NR UP and CP protocol layers between a UE (310), a gNB (320), and an AMF (330), such as those shown in FIGS. 1-2. Physical (PHY), Medium Access Control (MAC), Radio Link Control (RLC), and Packet Data Convergence Protocol (PDCP) layers between UE and gNB are common to UP and CP. PDCP provides ciphering/deciphering, integrity protection, sequence numbering, reordering, and duplicate detection for both CP and UP, as well as header compression and retransmission for UP data.

On the UP side, Internet protocol (IP) packets arrive to PDCP as service data units (SDUs), and PDCP creates protocol data units (PDUs) to deliver to RLC. The Service Data Adaptation Protocol (SDAP) layer handles quality-of-service (QoS) including mapping between QoS flows and Data Radio Bearers (DRBs) and marking QoS flow identifiers (QFI) in UL and DL packets. RLC transfers PDCP PDUs to MAC through logical channels (LCH). RLC provides error detection/correction, concatenation, segmentation/reassembly, sequence numbering, reordering of data transferred to/from the upper layers. MAC provides mapping between LCHs and PHY transport channels, LCH prioritization, multiplexing into or demultiplexing from transport blocks (TBs), hybrid ARQ (HARQ) error correction, and dynamic scheduling (in gNB). PHY provides transport channel services to MAC and handles transfer over the NR radio interface, e.g., via modulation, coding, antenna mapping, and beam forming.

On the CP side, the non-access stratum (NAS) layer between UE and AMF handles UE/gNB authentication, mobility management, and security control. RRC sits below NAS in the UE but terminates in the gNB rather than the AMF. RRC controls communications between UE and gNB at the radio interface as well as the mobility of a UE between cells in the NG-RAN. RRC also broadcasts system information (SI) and performs establishment, configuration, maintenance, and release of DRBs and Signaling Radio Bearers (SRBs) and used by UEs. Additionally, RRC controls addition, modification, and release of carrier aggregation (CA) and dual-connectivity (DC) configurations for UEs, and performs various security functions such as key management.

After a UE is powered ON it will be in the RRC_IDLE state until an RRC connection is established with the network, at which time the UE will transition to RRC_CONNECTED state (e.g., where data transfer can occur). The UE returns to RRC_IDLE after the connection with the network is released. In RRC_IDLE state, the UE's radio is active on a discontinuous reception (DRX) schedule configured by upper layers. During DR active periods (also referred to as “DRY On durations”), an RRC_IDLE UE receives SI broadcast in the cell where the UE is camping, performs measurements of neighbor cells to support cell reselection, and monitors a paging channel on PDCCH for pages from 5C via gNB. An NR UE in RRC_IDLE state is not known to the gNB serving the cell where the UE is camping. However, NR RRC includes an RRC_INACTIVE state in which a UE is known (e.g., via UE context) by the serving gNB. RRC_INACTIVE has some properties like a “suspended” condition used in LTE.

FIG. 4 is a block diagram illustrating a high-level architecture for UE positioning in NR networks. NG-RAN (420) can include gNBs (e.g., 422) and ng-eNBs (e.g., 421), similar to the architecture shown in FIG. 2. Each ng-eNB may control several transmission points (TPs), such as remote radio heads. Similarly, each gNB may control several TRPs. Some or all of the TPs/TRPs may be DL-PRS-only for support of PRS-based TBS.

In addition, the NG-RAN nodes communicate with an AMF (430) in the 5GC via respective NG-C interfaces (both of which may or may not be present), while the AMF communicates with a location management function (LMF, 440) via an NLs interface (441). An LMF supports various functions related to determination of UE locations, including location determination for a UE and obtaining DL location measurements or a location estimate from the UE, UL location measurements from the NG RAN, and non-UE associated assistance data from the NG RAN.

In addition, positioning-related communication between a UE (410) and the NG-RAN nodes occurs via RRC, while positioning-related communication between NG-RAN nodes and LMF occurs via an NRPPa protocol. Optionally, the LMF can also communicate with an enhanced serving mobile location center (E-SMLC, 450) and a secure UP location (SUPL) location platform (SLP, 460) via respective communication interfaces (451, 461), which can utilize and/or be based on standardized protocols, proprietary protocols, or a combination thereof. The E-SMLC is responsible for UE positioning via LTE CP while the SLP is responsible for UE positioning via UP.

The LMF can also include, or be associated with, various processing circuitry (442), by which the LMF performs various operations described herein. The LMF's processing circuitry can include similar types of processing circuitry as described herein in relation to other network nodes (see, e.g., descriptions of FIGS. 15 and 17). The LMF can also include, or be associated with, a non-transitory computer-readable medium (443) storing instructions (also referred to as a computer program program) that can facilitate the operations of the processing circuitry. The computer-readable medium can include similar types of computer memory as described herein in relation to other network nodes (see, e.g., descriptions of FIGS. 15 and 17). Additionally, the LMF can include various communication interface circuitry (441, e.g., Ethernet, optical, and/or radio transceivers) that can be used, e.g., for communication via the NLs interface. For example, the LMF's communication interface circuitry can be similar to other interface circuitry described herein in relation to other network nodes (see, e.g., descriptions of FIGS. 15 and 17).

Similarly, the E-SMLC can also include, or be associated with, various processing circuitry (452), by which the E-SMLC performs various operations described herein. The E-SMLC's processing circuitry can include similar types of processing circuitry as described herein in relation to other network nodes (see, e.g., descriptions of FIGS. 15 and 17). The E-SMLC can also include, or be associated with, a non-transitory computer-readable medium (453) storing instructions (also referred to as a computer program program) that can facilitate the operations of the processing circuitry. The computer-readable medium can include similar types of computer memory as described herein in relation to other network nodes (see, e.g., descriptions of FIGS. 15 and 17). The E-SMLC can also include communication interface circuitry that is appropriate for communicating via an interface (451), which can be similar to other interface circuitry described herein in relation to other network nodes (see, e.g., descriptions of FIGS. 15 and 17).

Similarly, the SLP can also include, or be associated with, various processing circuitry (462), by which the SLP performs various operations described herein. The SLP's processing circuitry can include similar types of processing circuitry as described herein in relation to other network nodes (see, e.g., descriptions of FIGS. 15 and 17). The SLP can also include, or be associated with, a non-transitory computer-readable medium (463) storing instructions (also referred to as a computer program program) that can facilitate the operations of the processing circuitry. The computer-readable medium can include similar types of computer memory as described herein in relation to other network nodes (see, e.g., descriptions of FIGS. 15 and 17). The SLP can also include communication interface circuitry that is appropriate for communicating via an interface (461), which can be similar to other interface circuitry described herein in relation to other network nodes (see, e.g., descriptions of FIGS. 15 and 17).

In typical operation, the AMF can receive a request for a location service associated with a particular target UE from another entity (e.g., a gateway mobile location center (GMLC)), or the AMF itself can initiate some location service on behalf of a particular target UE (e.g., for an emergency call from the UE). The AMF then sends a location services (LS) request to the LMF. The LMF processes the LS request, which may include transferring assistance data to the target UE to assist with UE-based and/or UE-assisted positioning; and/or positioning of the target UE. The LMF then returns the result of the LS (e.g., a position estimate for the UE and/or an indication of any assistance data transferred to the UE) to the AMF or to another entity (e.g., GMLC) that requested the LS.

Various interfaces and protocols are used for, or involved in, NR positioning. The LTE Positioning Protocol (LPP) is used between a target device (e.g., UE in the control-plane, or SET in the user-plane) and a positioning server (e.g., LMF in the control-plane, SLP in the user-plane). LPP can use either CP or UP protocols as underlying transport. NRPP is terminated between a target device and the LMF. RRC protocol is used between UE and gNB (via NR radio interface) and between UE and ng-eNB (via LTE radio interface).

Furthermore, the NR Positioning Protocol A (NRPPa) carries information between the NG-RAN Node and the LMF and is transparent to the AMF. As such, the AMF routes the NRPPa PDUs transparently (e.g., without knowledge of the involved NRPPa transaction) over NG-C interface based on a Routing ID corresponding to the involved LMF. More specifically, the AMF carries the NRPPa PDUs over NG-C interface either in UE associated mode or non-UE associated mode. The NGAP protocol between the AMF and an NG-RAN node (e.g., gNB or ng-eNB) is used as transport for LPP and NRPPa messages over the NG-C interface. NGAP is also used to instigate and terminate NG-RAN-related positioning procedures.

LPP/NRPP are used to deliver messages such as positioning capability request, positioning measurements request, and assistance data to the UE from a positioning node (e.g., LMF). LPP/NRPP are also used to deliver messages from the UE to the positioning node including, e.g., UE capability, UE measurements for UE-assisted positioning, UE request for additional assistance data, UE configuration parameter(s) to be used to create UE-specific assistance data, etc. NRPPa is used to deliver the information between ng-eNB/gNB and LMF in both directions. This can include LMF requesting some information from ng-eNB/gNB, and ng-eNB/gNB providing some information to LMF. For example, this can include information about PRS transmitted by ng-eNB/gNB that are to be used for positioning measurements by the UE.

The following positioning methods are supported in NR:
Enhanced Cell ID (E-CID). Utilizes information to associate the UE with the geographical area of a serving cell, and then additional information to determine a finer granularity position. The following measurements are supported for E-CID: AoA (base station only), UE Rx-Tx time difference, timing advance (TA) types 1 and 2, reference signal received power (RSRP), and reference signal received quality (RSRQ).
Assisted GNSS. The UE receives and measures Global Navigation Satellite System (GNSS) signals, supported by assistance information provided to the UE from E-SMLC.
DL Time Difference of Arrival (DL-TDoA). The UE measures reference signal time differences (RSTD) between DL RS (e.g., PRS) transmitted by different RAN nodes.
UL Relative Time of Arrival (UL-RToA). The UE is requested to transmit a specific waveform that is detected by multiple location measurement units (LMUs, which may be standalone, co-located or integrated into an eNB) at known positions. These measurements are forwarded to the E-SMLC for multilateration.
Multi-Round Trip Time (RTT): The UE computes UE Rx-Tx time difference and gNBs compute gNB Rx-Tx time difference. The results are combined to find the UE position based upon round trip time (RTT) calculation.
DL angle of departure (DL-AoD): gNB or LMF calculates the UE angular position based upon UE DL RSRP measurement results (e.g., of PRS transmitted by RAN nodes).
UL angle of arrival (UL-AoA): gNB calculates the UL AoA based upon measurements of a UE's UL SRS transmissions.

Different ones of these positioning methods are based on timing measurements, which can be unidirectional or bidirectional. Unidirectional timing measurement can include a first node measuring transmit timing of a signal transmitted by the first node or reception timing of signal received by the first node that was transmitted by a second node. Bidirectional timing measurement can include a first node measuring relation between the transmit timing of signal transmitted by the first node and the reception timing of signal received by the first node from the second node. An example of a bidirectional measurement is difference between transmission and reception timing.

In example timing measurements, the first node may measure absolute reception timing of a signal and/or relative reception timing of the signal with respect to a reference time. Similarly, the first node may measure absolute transmission timing of a signal and/or relative transmission timing of the signal with respect to a reference time.

In the NR positioning methods listed above, RTT uses bidirectional timing measurements including UE Rx-Tx time difference, gNB Rx-Tx time difference, time advance (TA), etc. In the NR positioning methods listed above, unidirectional timing measurements include RSTD performed by the UE, UL RToA performed by the gNB, etc. These are explained in more detail below.
RSTD: measured by UE on the DL PRS signals transmitted by positioning node j and reference positioning node i. RSTD always involves two cells (also referred to as TRPs).
UE Rx-Tx time difference: defined as T_{UE-RX}−T_{UE-TX}, where:
   T_{UE-RX} is UE receive timing of DL subframe #i, defined by the first path detected in time, measured on PRS received from the gNB.
   T_{UE-TX} is UE transmit timing of UL subframe #j closest in time to DL subframe #i.
gNB Rx-Tx time difference: define as T_{gNB-RX}−T_{gNB-TX}, where:
   T_{gNB-RX} is gNB received timing of UL subframe #i containing SRS transmitted by/received from the UE, defined by the first path detected in time, is measured on SRS signals received from the UE.
   T_{gNB-TX} is gNB transmit timing of DL subframe #j closest in time to UL subframe #i.
Timing advance (T_{ADV}), defined as T_{ADV}=(T_{gNB-RX}−T_{gNB-TX}), where:
   T_{gNB-RX} is TRP received timing of UL subframe #i containing PRACH transmitted by/received from the UE, defined by the first path detected in time.
   T_{gNB-TX} is TRP transmit timing of DL subframe #j closest in time to UL subframe #i.
   Detected PRACH is used to determine the start of a subframe containing that PRACH.
UL-RToA: gNB/TRP reception timing of beginning of subframe i containing SRS transmitted by/received from the UE, relative to a configurable reference time.

NR supports positioning both in frequency region 1 (FR1, e.g., below 6 GHz) and frequency region 2 (FR2, e.g., above 6 GHz). PRS in FR2 can be configured with bandwidths as wide as 400 MHz, and can be beamformed to compensate for the higher propagation loss in FR2. Additionally, a UE may be equipped with multiple antenna panels for operation in higher frequencies such as FR2.

For example, a UE operating in millimeter wave frequencies for mobile broadband may have three antenna panels on different UE surfaces (e.g., sides or edges). Each panel may include four dual-polarized antenna elements, with one panel being active for communication purposes at a given time. The delay between UE baseband timing and actual antenna Rx/Tx timing may differ between the various antenna panels, e.g., due to different group delays.

For positioning measurements, these timing differences will affect the achievable accuracy. In some cases, per-panel delays could be compensated to some extent by estimating them based on theoretical calculations and/or measurements performed on individual UEs. The known part of the delays could be compensated for by calibrating each UE to adapt its baseband Tx timing depending on the currently active antenna panel. Similarly, a UE could be calibrated to account for estimated per-panel delays in ToA measurements of received signals. Even so, estimates of the per-panel delays will be imprecise, especially since delays may vary with time and frequent calibration of individual UE can be complex and/or time consuming. Consequently, measurements of UE Rx/Tx timing at the antenna will have some error and variance across UEs and antenna panels, which ultimately introduces errors in RSTD and other positioning measurements.

To overcome the impact of timing difference between UE panels for positioning measurements, a new feature called timing error group (TEG) is introduced in Rel-17 NR positioning. This feature allows a UE to assign each of its antenna panels a TEG identity (ID). A UE with multiple panels reports positioning measurements along with the TEG ID associated with the panels used to perform the respective measurements. Such measurement reporting is more prominent in FR2 where UE may exploit multiple panels for positioning measurements such as RSTD and UE RxTx. In this way, the network can combine UE measurements from same TEGs to group RSTD and RxTx measurements such that the timing delay due to TEG cancels out and enhanced positioning accuracy can be achieved. The TEG IDs inform the LMF which UE measurements can be combined to cancel and/or mitigate TX timing errors.

Different types of TEGs have been introduced in Rel-17 for both UE and TRP, including:
UE Tx TEG: associated with the transmissions of one or more UL SRS resources for the positioning purpose, which have the Tx timing error difference within a certain margin.
UE Rx TEG: associated with one or more DL measurements, which have the Rx timing error difference within a certain margin.
UE RxTx TEG: associated with one or more UE Rx-Tx time difference measurements, which have the ‘Rx timing errors+Tx timing errors’ difference within a certain margin.
TRP Tx TEG: associated with the transmissions of one or more DL PRS resources, which have the Tx timing error difference within a certain margin.
TRP Rx TEG: associated with one or more UL measurements, which have the Rx timing error difference within a margin.
TRP RxTx TEG: associated with one or more gNB Rx-Tx time difference measurements, which have the ‘Rx timing errors+Tx timing errors’ within a certain margin.

If a node performing positioning measurement(s) has more than one TEG, the positioning measurements are associated with a TEG ID. Based on the reported measurement and the associated TEG ID, the LMF can understand which measurements can be combined to estimate the UE position.

Larger measurement bandwidths are preferred to support high-accuracy timing/ranging measurements in use cases that demand high positioning accuracy. NR DL PRS can be configured to occupy up to 100 MHz bandwidth in FR1 and, as noted above, up to 400 MHz bandwidth in FR2. Since the bandwidth that can be allocated to PRS (or UL SRS) is limited, bandwidth aggregation for positioning is being studied in Rel-18 as a way to increase accuracy of timing/ranging measurements. The scope of the Rel-18 study is to identify solutions that can ensure joint/coherent processing of PRS resources received from different carriers/PFLs for positioning measurements, specifically to study solutions for accuracy improvement based on PRS/SRS bandwidth aggregation for intra-band carriers, considering timing error, phase coherency, frequency errors, power imbalance, etc.

3GPP Rel-17 supports PRS configuration in multiple frequency carriers/positioning frequency layers (PFLs), but does not support aggregation of resources from different carriers/PFLs to form wider-bandwidth PRS, which can improve accuracy and/or precision of positioning measurements as noted above.

Moreover, certain conditions need to be met for bandwidth aggregation for positioning measurements to provide the desired benefits. In addition, a UE should be provided with assistance data from which the UE can understand the resources it can combine for positioning measurements. Furthermore, when aggregating positioning resources from multiple carriers/PFLs, the resources from each of the multiple carriers/PFLs may have a slightly different timing error/offset than the others, e.g., due to transmission and/or reception through different antenna panels and/or transmit-receive chains. These timing differences must be accounted for to achieve the improved accuracy and/or precision due to aggregation. Solutions to these problems, issues, and/or difficulties are needed.

Embodiments of the present disclosure can address these and other problems, issues, and/or difficulties with flexible and efficient techniques for a positioning node (e.g., LMF) to inform UEs about which PRS resources can be aggregated based on PRS transmission characteristics (e.g., TEG), for a UE to selectively aggregate PRS resources based on UE reception characteristics (e.g., TEG), and for a UE to report with positioning measurements whether and/or what type of PRS bandwidth aggregation was used by the UE when performing the positioning measurements.

Embodiments can provide various benefits and/or advantages. For example, embodiments facilitate UE bandwidth aggregation (e.g., multiple carriers/PFLs) for positioning measurements and network knowledge of such UE bandwidth aggregation, thereby enabling the use of bandwidth-aggregated positioning measurements to increase positioning accuracy and/or precision.

Embodiments can be summarized as follows. A positioning node (e.g. LMF) obtains information about two or more groups of carriers (e.g. PFLs) which are transmitted/received by a RAN node (e.g. TRP) using respective radio chains (e.g., antenna ports). The positioning node can obtain the information by receiving a message (e.g. NRPPa) from the RAN node and/or from a UE, e.g., after the UE obtains the information from the RAN node. The information can include a relation or association between the groups of carriers and their respective radio chains. The positioning node uses the information to determine two or more carriers on which reference signals (e.g. PRS/SRS) can be aggregated for UE positioning measurements. The positioning node sends the UE a positioning configuration including the determined two or more carriers (e.g., as positioning assistance data), which enables the UE to perform the positioning measurements by aggregating the reference signals (e.g. PRS/SRS) on the two or more carriers. In some embodiments, the positioning node may further indicate which PRS resources on the carriers can be aggregated.

Based on this information and on the TEG information for the UE's own radio chains, the UE can determine bandwidth aggregation to use when performing the positioning measurements, which can be reported to the positioning node together with the measurements. For example, the UE radio chain may include multiple UE Rx TEGs used to receive a plurality of PRSs, and the UE determines whether to perform aggregated positioning measurement over the plurality of PRSs or to perform separate positioning measurements over the plurality of PRSs. As another example, the UE radio chain may include multiple UE Rx phase error groups (PEGs) used to receive a plurality of PRSs, and the UE determines whether to perform aggregated positioning measurement over the plurality of PRSs or to perform separate positioning measurements over the plurality of PRSs.

Embodiments will now be described in more detail. In some embodiments, a PRS aggregation identifier (ID) is used to identify PRS resources that can be aggregated by UE to perform positioning measurements. For example, an aggregated bandwidth can be larger than 100 MHz in FR1 and larger than 400 MHz in FR2. A single PRS aggregation ID identifies PRS resources that share one or more of the following characteristics:
PRS resources in different carriers/PFLs with same PRS aggregation ID are transmitted by same Tx RF chain at TRP, or
PRS resources in different carriers/PFLs with same PRS aggregation ID are transmitted by maintaining phase coherency between them.
Measurements reported with an attached aggregation ID are made on PRSs received with the same RF chain or with RF chains that maintain phase coherency.

In some embodiments, DL PRS resources that can be aggregated by UE to perform positioning measurement are indicated to the UE by a positioning node (e.g., LMF). For example, the positioning node includes an PRS aggregation ID as a part of DL PRS resource configuration. When multiple DL PRS resources are configured with the same PRS aggregation ID, it indicates that the UE can aggregate the multiple DL PRS resources for positioning measurements, e.g., for coherent/joint processing. In some of these embodiments, when a PRS resource configuration does not include an PRS aggregation ID, this indicates that the PRS resource may not be combined with another PRS resource by the UE unless the UE performs its own compensation to obtain phase coherency between the PRS resources.

In some embodiments, the number of DL PRS resources that can be aggregated for positioning measurement is configured by the positioning node. The minimum number (N) of PRS resources that can be aggregated can be N≥2. In other words, when the UE is configured to aggregate N PRS resources then N DL PRS resources with same PRS aggregation ID can be jointly processed by UE for positioning measurements. In different variants, the value N may depend on the UE capability reported to the network or may be a maximum value based on number of bands supported by the UE and/or number of carriers the UE can aggregate within a band.

In some embodiments, when present in a PRS configuration, a PRS aggregation ID can take on integer value between 0 and X≥1. Each PRS aggregation ID value may be associated with a number of groups of DL PRS resources that can be measured and coherently/jointly processed.

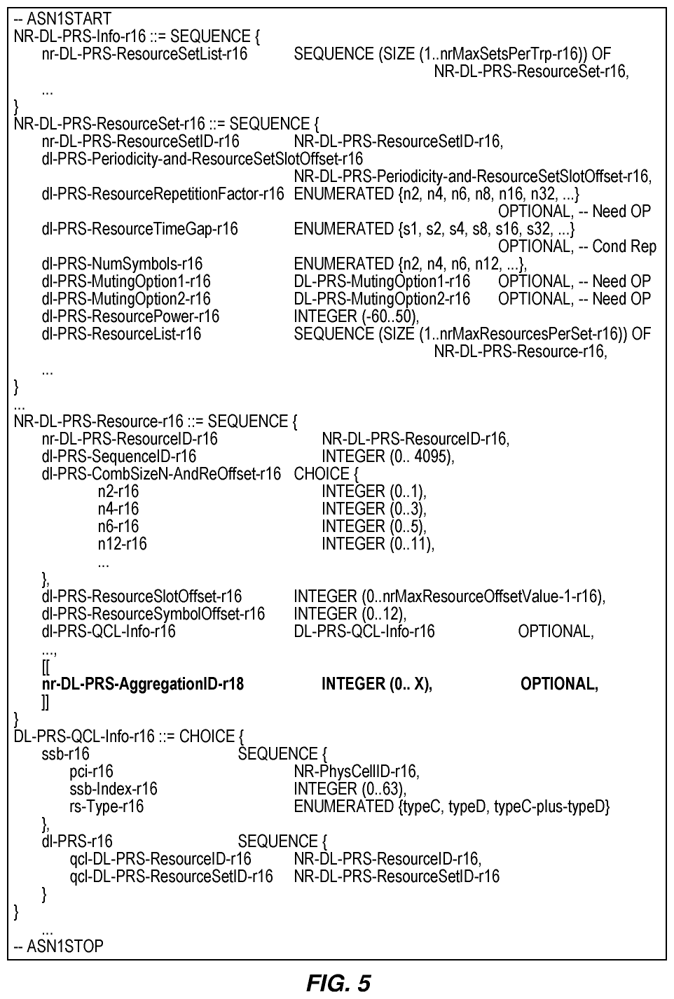

FIG. 5 shows an ASN.1 data structure for an exemplary NR-DL-PRS-Info information element (IE), according to some embodiments of the present disclosure. In this IE, the NR-DL-PRS-Resource-r16 field includes nr-DL-PRS-AggregationID-r18 as a sub-field. In other words, the PRS aggregation ID is configured per PRS resource.

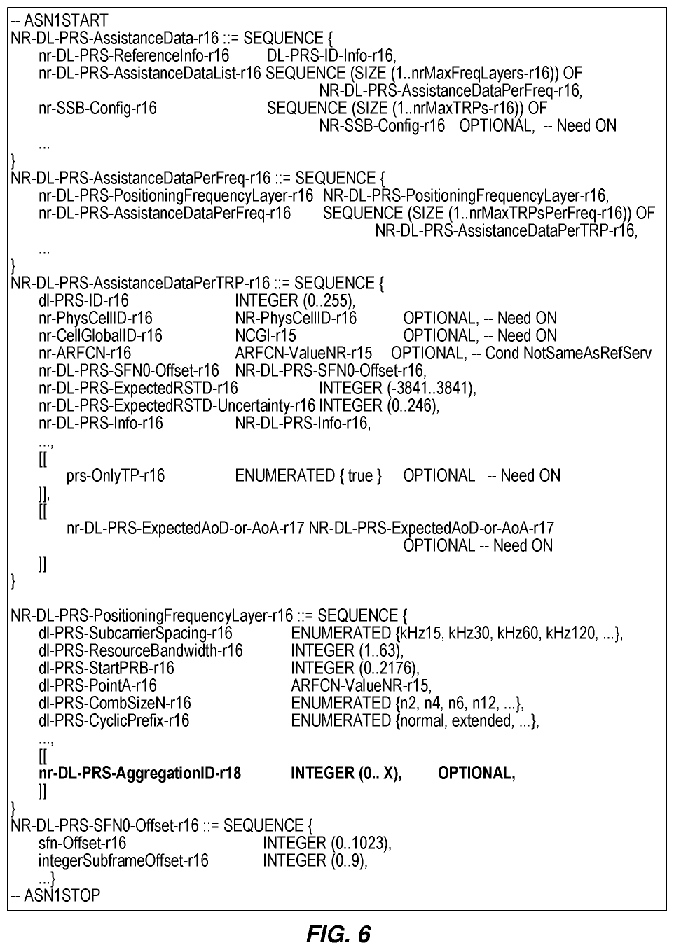

In a variant, the PRS aggregation ID can be configured per PFL. If PRS aggregation ID is provided at PFL level, the UE can be configured to aggregate DL PRS resources in different PFLs. In this case, the UE jointly processes two DL PRS resources when they belong to different PFLs that are associated with the same PRS aggregation ID. FIG. 6 shows an ASN.1 data structure for an exemplary NR-DL-PRS-AssistanceData IE, according to these embodiments. In this IE, the NR-DL-PRS-PositoiningFrequencyLater-r16 field includes nr-DL-PRS-AggregationlD-r18 as a sub-field.

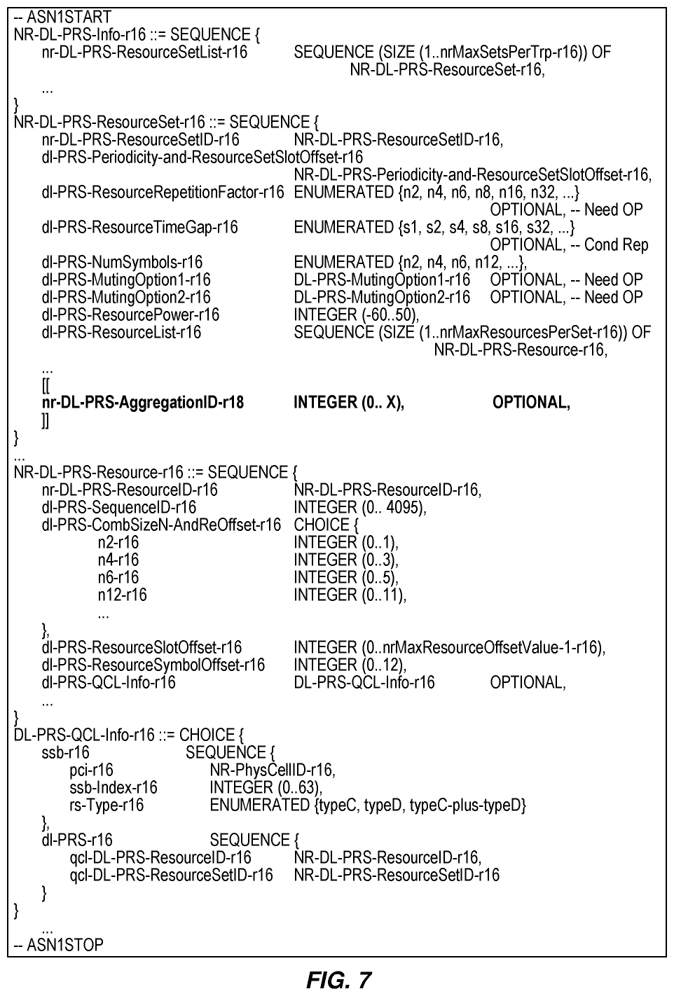

In another variant, the PRS aggregation ID can be configured per PRS resource set. In this case, a UE may be configured to aggregate PRS resources belonging to different DL PRS resource sets that are associated with the same PRS aggregation ID. FIG. 7 shows an ASN.1 data structure for another exemplary NR-DL-PRS-Info IE, according to these embodiments. In this IE, the NR-DL-PRS-ResourceSet-r16 field includes nr-DL-PRS-AggregationlD-r18 as a sub-field.

The embodiments described above, including the examples shown in FIGS. 5-7, are based on the positioning node (e.g., LMF) configuring UE DL PRS resources via the LPP protocol. In other embodiments, the UE's DL PRS resources can be configured by the serving RAN node via RRC, which can be beneficial when multiple TRPs belong to the same serving cell and are controlled by the same RAN node (e.g., gNB).

Furthermore, the embodiments described above are applicable to DL PRS resources that are aperiodic or semi-persistent. Aperiodic DL PRS are higher-layer configured and triggered by a field in downlink control information (DCI), while semi-persistent DL PRS are higher-layer configured and activated/deactivated via MAC control element (CE).

Furthermore, the embodiments described above may be extended to other RS (e.g., NZP CSI-RS, TRS, etc.) that can be used for positioning measurements. For instance, an index or sub-field may be included in a configuration of a NZP CSI-RS resource or resource set to indicate whether one or more NZP CSI-RS resources may be coherently/jointly processed for positioning measurements.

As mentioned above, 3GPP Rel-17 introduced TEG for positioning measurement. When UE has more than one TEG and aggregates PRS resources from different carriers/PFLs for positioning measurement, then the following embodiments can apply.

In some embodiments, PRS resources from different carriers/PFLs to be jointly/coherently processed are received by UE via the same UE RX chain, which is identified by a UE Rx TEG ID. The UE includes with the positioning measurements sent to the positioning node the UE Rx TEG ID associated with the UE Rx chain used to receive the aggregated PRS resources from different carriers/PFLs.

In some embodiments, PRS resources from different carriers/PFLs to be jointly/coherently processed by the UE are transmitted by the TRP via the same TRP Tx chain, which is identified by the TRP Tx TEG ID.

In some embodiments, PRS resources from different carriers/PFLs to be jointly/coherently processed are received by UE using different UE Rx chains. In this case, the UE aggregates the PRS resources and indicates to the positioning node that the aggregated resources for positioning measurement are received via different UE Rx chains, e.g., by sending associated UE Rx TEG IDs. In another variant, the UE does not aggregate the PRS resources but performs separate measurements on the respective PRS resources. In this case, the separate measurements are reported to the network along with the respective UE Rx TEG IDs used for each separate measurement.

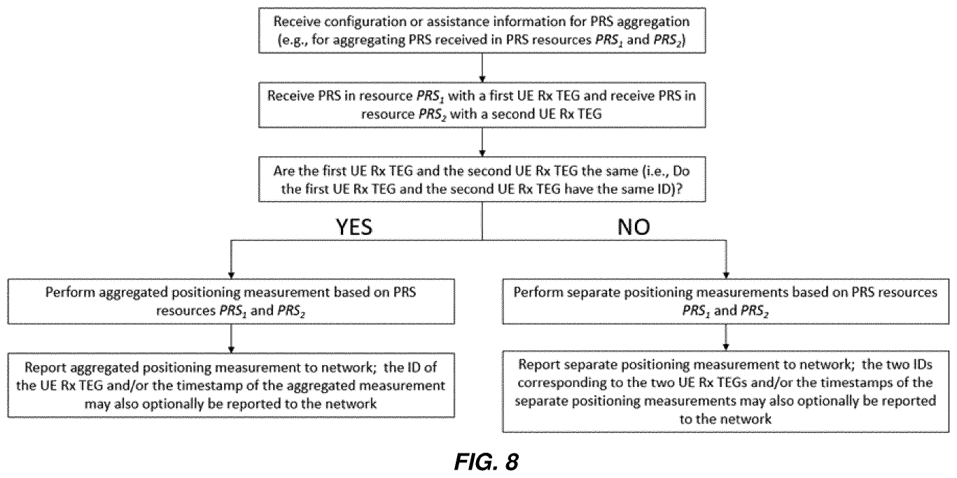

FIG. 8 shows a flow diagram of a procedure for selective bandwidth aggregation for positioning measurements, according to some embodiments of the present disclosure. In particular, the UE determines whether to perform aggregated or separate positioning measurements based on the UE Rx TEGs used to receive two PRS, based on PRS aggregation assistance (e.g., PRS Aggregation ID) received from the positioning node according to any of the embodiments described above.

In this example, the UE receives configurations for two PRS resources, PRS1-2, which indicate that these resources can be aggregated for positioning measurements (e.g., by common PRS aggregation ID). The UE receives PRS in PRS1 with a first UE Rx TEG and in PRS2 with a second UE Rx TEG. If the first and second UE Rx TEGs have the same ID, the UE performs and reports aggregated positioning measurements (“Yes”) along with the UE Rx TEG ID. If the first and second UE Rx TEGs have different IDs, then the UE performs and reports separate positioning measurements in the two PRS resources, along with the respective UE Rx TEG IDs. The timestamp(s) of the aggregated or separate positioning measurement may also be included in the UE's measurement report.

In other embodiments, if the UE receives PRS in two PRS resources with different UE Rx TEGs, then the UE skips separate measurements on the two PRS resources and refrains from sending separate positioning reports to the network. In other embodiments, if the UE receives PRS in the two PRS resources with different UE Rx TEGs, then the UE performs a positioning measurement on one of the two PRS resources and report the positioning measurement along with the associated UE Rx TEG ID.

In other embodiments, if PRS aggregation ID is configured per PFL level (i.e., PRS resources belonging to different PFLs are aggregated), then the UE chooses two or more PRS from the different PFLs to perform aggregated positioning measurements, so long as the two or more PRSs can be received by the UE using the same UE Rx TEGs.

In other embodiments, if PRS aggregation ID is configured per PRS resource set (i.e., PRS resources belonging to different PRS resource sets are aggregated), then the UE chooses two or more PRS from the different PRS resource sets to perform aggregated positioning measurements, as long as the two or more PRS can be received using the same UE Rx TEGs.

The above embodiments are described based on UE Rx TEGs, but can be generalized to include scenarios in which PRS resources are measured using UE RxTx TEGs.

The above embodiments are described from DL PRS perspective, but can be generalized to also include UL SRS used for positioning. In this case, a RAN node (e.g., gNB, TRP) will be performing the above-described operations attributed to the UE, and will report the aggregated or separate measurement reports to the positioning node.

Other embodiments involve UE-based selective bandwidth aggregation based on phase error groups (PEGs), also referred to as “phase coherent error groups”. In some embodiments, PRS resources from different carriers/PFLs to be jointly/coherently processed are received by UE from the same PEG. The PEG in this scenario is identified by the PEG ID of the receiving node (i.e., UE Rx PEG ID). The receiving node reports the measurement to LMF indicating Rx PEG ID associated with the positioning measurement performed by aggregating PRS resources from different carriers/PFLs.

In some embodiments, PRS resources from different carriers/PFLs that are capable of being jointly/coherently processed are received by UE from different UE Rx PEGs. In some variants, the UE aggregates these PRS resources for positioning measurements and indicates to the positioning node that the aggregated resources used for the positioning measurements were received via different Rx PEGs. In other variants, the UE does not aggregate these PRS resources but performs positioning measurements on individual ones of the PRS resources, and includes with each reported measurement with the associated Rx PEG ID.

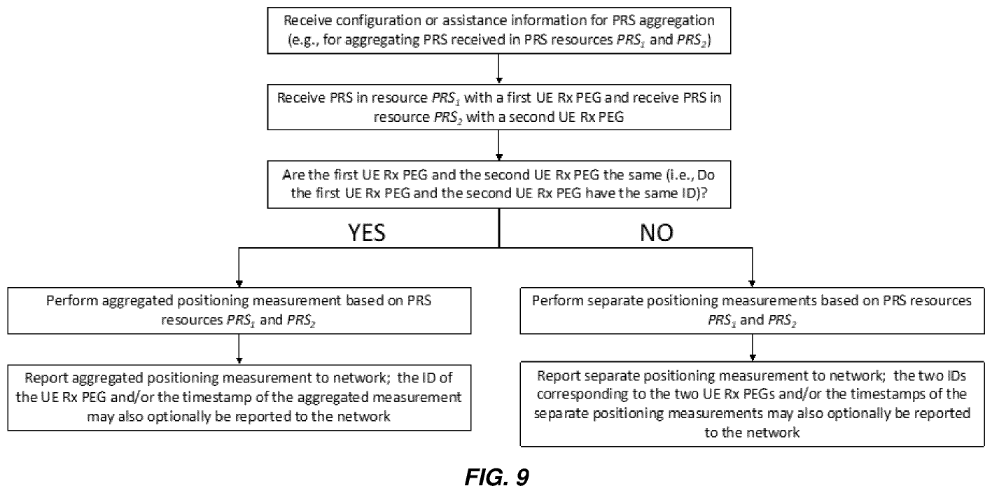

FIG. 9 shows a flow diagram of another procedure for selective aggregation of PRS resources for positioning measurements, according to some embodiments of the present disclosure. In this example, the UE receives configurations for two PRS resources, PRS1-2, which indicate that these resources can be aggregated for positioning measurements (e.g., by common PRS aggregation ID). The UE receives PRS in PRS1 with a first UE Rx PEG and in PRS2 with a second UE Rx PEG. If the first and second UE Rx PEGs have the same ID, the UE performs and reports aggregated positioning measurements (“Yes”) along with the UE Rx PEG ID. If the first and second UE Rx PEGs have different IDs, then the UE performs and reports separate positioning measurements in the two PRS resources, along with the respective UE Rx PEG IDs.

In general, certain conditions may need to be met in order for two or more DL PRS resources to be coherently/jointly processed by a UE. When the relevant conditions are not met, the UE does not coherently/jointly process the two or more DL PRS resources. In some variants, when the relevant conditions are not met, the UE processes one of the two or more DL PRS resources. In other variants, when the relevant conditions are not met, the UE processes each of the two or more DL PRS resources separately and/or individually. Various embodiments relating to different conditions are described below.

In some embodiments, to be coherently/jointly processed, the two or more DL PRS resources must be transmitted from the same TRP. In NR Rel-16, the TRP is represented by dl-PRS-ID (e.g., 3GPP TS 37.355 v16.2.0); thus two or more DL PRS resources can only be coherently/jointly processed if they correspond to the same dl-PRS-ID value.

In some embodiments, to be coherently/jointly processed, the two or more DL PRS resources need to be received by the UE in the same slot so that coherency holds. In a variant, the two or more DL PRS resources need to be received with the same periodicity and/or slot offset. This means that the dl-PRS-Periodicity-and-ResourceSetSlotOffset-r16 fields in the DL PRS resource set configurations (i.e., NR-DL-PRS-ResourceSet-r16) for each of the DL PRS resources need to have the same value. In other variants, the two or more DL PRS resources to be coherently/jointly processed need to have the same slot offset value defined in their DL PRS resource configurations (e.g., the dl-PRS-ResourceSlotOffset-r16 field values associated with these two or more DL PRS resources to be coherently/jointly processed may need to have the same value).

In some embodiments, to be coherently/jointly processed, the two or more DL PRS resources need to be received by the UE in the same symbol so that coherency holds. In a variant, the two or more DL PRS resources need to have the same symbol offset value (e.g., dl-PRS-ResourceSlotOffset-r16 field) defined in their respective PRS resource configurations.

In some embodiments, to be coherently/jointly processed, the two or more DL PRS resources need to be limited to a single repetition. This can mean, for example, that the dl-PRS-ResourceRepetitionFactor-r16 field is not configured in the DL PRS resource set configurations (i.e., NR-DL-PRS-ResourceSet-r16) associated with the two or more DL PRS resources. Alternately, to be coherently/jointly processed, the two or more DL PRS resources need to be limited to a maximum number of repetitions Mₘₐₓ>1. In this alternative, the dl-PRS-ResourceRepetitionFactor-r16 field should have the same value (≤Mₘₐₓ) in the DL PRS resource set configurations (i.e., NR-DL-PRS-ResourceSet-r16) associated with the two or more DL PRS resources.

In some embodiments, to be coherently/jointly processed, the two or more DL PRS resources need to be received by the UE with the same QCL arrangement (e.g., same beam or same QCL type D source RS). This can mean, for example, that the two more DL PRS resources have the same content of the dl-PRS-QCL-Info-r16 fields in their respective DL PRS resource configurations.

In some other embodiments, o be coherently/jointly processed, the two or more DL PRS resources need to belong to different frequency layers. This can mean, for example, that one or more of the parameter values in the respective nr-DL-PRS-PositioningFrequencyLayer-r16 fields for the two or more DL PRS resources need to be different.

In some embodiments, to be coherently/jointly processed, the two or more DL PRS resources need to have the same numerology. In some variants, the two or more DL PRS resources need to have the same numerology but can have different bandwidths.

In some embodiments, to be coherently/jointly processed, the two or more DL PRS resources need to be transmitted by the same radio chain or have the same Tx TEG and/or Tx PEG.

As specified in 3GPP TS 38.455 (v16.1.0), a positioning node (e.g., LMF) sends TRP INFORMATION REQUEST messages to a RAN nodes for information on TRPs hosted by the RAN node. The RAN node may send a TRP INFORMATION RESPONSE message including the requested information. A TRP Information IE in the TRP INFORMATION RESPONSE message carries the PRS configuration used by a TRP.

In some embodiments, the positioning node sends a request to a RAN node for a list of PRS resources that may be used for aggregation. The request may be a field or IE in a TRP INFORMATION REQUEST message or a separate and/or different message. The RAN node responds with the requested information using a hierarchy of PRS resources, PRS resource sets, and/or PFLs. The provided information may be included as a field or IE in the TRP INFORMATION RESPONSE message that includes the PRS configuration, or as a separate and/or different message. The provided information may include one or more of the following:
list of PFLs and respective PRS aggregation IDs;
list of PRS resource sets and respective PRS aggregation IDs; and
list of PRS resources and respective PRS aggregation IDs.

Whether DL PRS resources can be coherently transmitted by the TRP (including via same radio chain) needs to be indicated to the positioning node. In some embodiments, a PRS aggregation ID is included at the PRS Resource Set level. Table 1 below shows an example of these embodiments, in the context of an enhanced PRS Resource Set List IE defined for 3GPP TS 38.455 (v17.2.0), i.e., NRPPa protocol. If two PRS resource sets have the same value of PRS aggregation ID, all PRS in two PRS resource sets can be coherently transmitted by the TRP implying resources in the resource sets are transmitted from the same Tx TEG, radio chain, or Tx PEG. In some embodiments, the maximum value X of the PRS aggregation ID is fixed in specifications.

TABLE 1

| | | | | Semantics |
|---|---|---|---|---|
| IE/Group Name | Pres. | Range | IE Type/Ref. | Description |
| PRS Resource Set | | 1 . . . <maxnoofPRSresourceSet> | | |
| List | | | | |
| >PRS Resource Set | M | | INTEGER(0 . . . 7) | |
| ID | | | | |
| >PRS Aggregation | O | | INTEGER(0 . . . X) | |
| ID | | | | |
| >Subcarrier Spacing | M | | ENUMERATED(kHz15, | |
| | | | kHz30, kHz60, kHz120, . . . ) | |
| >PRS bandwidth | M | | INTEGER(1 . . . 63) | 24, 28, . . . , 272 |
| | | | | PRBs |
| >Start PRB | M | | INTEGER(0 . . . 2176) | Starting PRB |
| | | | | to Point A |
| >Point A | M | | INTEGER (0 . . . 3279165) | NR ARFCN |
| >Comb Size | M | | ENUMERATED | |
| | | | (2, 4, 6, 12, . . . ) | |
| >CP Type | M | | ENUMERATED | |
| | | | (normal, extended, . . . ) | |
| >Resource Set | M | | ENUMERATED(4, 5, 8, 10, 16, | |
| Periodicity | | | 20, 32, 40, 64, 80, 160, 320, 640, | |
| | | | 1280, 2560, 5120, 10240, 20480, | |
| | | | 40960, 81920, . . . ) | |
| >Resource Set Slot | M | | INTEGER(0 . . . 81919, . . . ) | |
| Offset | | | | |
| >Resource Repetition | M | | ENUMERATED(rf1, rf2, rf4, | |
| Factor | | | rf6, rf8, rf16, rf32, . . . ) | |
| >Resource Time Gap | M | | ENUMERATED(tg1, tg2, tg4, | |
| | | | tg8, tg16, tg32, . . . ) | |
| >Resource Number | M | | ENUMERATED | |
| of Symbols | | | (n2, n4, n6, n12, . . . ) | |
| >PRS Muting | O | | | |
| >>Option1 | O | | | |
| >>>Muting | M | | 9.2.56 | |
| Pattern | | | | |
| >>>Muting Bit | M | | ENUMERATED(1, 2, 4, 8, . . . ) | |
| Repetition Factor | | | | |
| >>Option2 | O | | | |
| >>>Muting | M | | DL-PRS Muting Pattern | |
| Pattern | | | 9.2.56 | |
| >PRS Resource | M | | INTEGER(−60 . . . 50) | |
| Transmit Power | | | | |
| >PRS Resource List | | 1 | | NR-DL-PRS- |
| | | | | Resource-r16 |
| | | | | defined in TS |
| | | | | 37.355 |
| >>>PRS Resource | | 1 . . . <maxnoofPRSresources> | | |
| Item | | | | |
| >>PRS Resource | M | | INTEGER(0 . . . 63) | |
| ID | | | | |
| >>Sequence ID | M | | INTEGER(0 . . . 4095, . . . ) | |
| >>RE Offset | M | | INTEGER(0 . . . 11) | |
| >>Resource Slot | M | | INTEGER(0 . . . 511, . . . ) | |
| Offset | | | | |
| >>Resource | M | | INTEGER(0 . . . 12, . . . ) | |
| Symbol Offset | | | | |
| >>QCL Info | O | | | |
| >>>QCL Source | O | | INTEGER(0 . . . 63) | |
| SSB Index | | | | |
| >>>QCL Source | O | | | |
| PRS Info | | | | |
| >>>>QCL | M | | INTEGER(0 . . . 7) | |
| Source PRS | | | | |
| Resource Set ID | | | | |
| >>>>QCL | O | | INTEGER(0 . . . 63) | If absent, QCL |
| Source PRS | | | | source PRS |
| Resource ID | | | | resource ID is |
| | | | | same as PRS |
| | | | | resource ID |

In other embodiments, a PRS aggregation ID is included at the PRS Resource level. Table 1 below shows an example of these embodiments, in the context of an enhanced PRS Resource Set List IE defined for 3GPP TS 38.455 (v17.2.0), i.e., NRPPa protocol. If two PRS resources have the same value of PRS aggregation ID, then these two PRS resources can be coherently transmitted by the TRP. In some embodiments, the maximum value X of the PRS aggregation ID is fixed in specifications. Note that PRS aggregation ID is an optional parameter in these embodiments, and if not included for a particular PRS resource, it implies that this PRS resource cannot be aggregated with other PRS resources (e.g., unless PRS aggregation ID is included at another hierarchy level such as PRS resource set or PFL). The positioning node takes into account the PRS aggregation information provided in this embodiment when configuring the DL PRS to the UE via LPP protocol.

TABLE 2

| | | | | Semantics |
|---|---|---|---|---|
| IE/Group Name | Pres. | Range | IE Type/Ref. | Description |
| PRS Resource Set | | 1 . . . <maxnoofPRSresourceSet> | | |
| List | | | | |
| >PRS Resource Set | M | | INTEGER(0 . . . 7) | |
| ID | | | | |
| >Subcarrier Spacing | M | | ENUMERATED(kHz15, | |
| | | | kHz30, kHz60, kHz120, . . . ) | |
| >PRS bandwidth | M | | INTEGER(1 . . . 63) | 24, 28, . . . , 272 |
| | | | | PRBs |
| >Start PRB | M | | INTEGER(0 . . . 2176) | Starting PRB |
| | | | | to Point A |
| >Point A | M | | INTEGER (0 . . . 3279165) | NR ARFCN |
| >Comb Size | M | | ENUMERATED(2, 4, 6, 12, . . . ) | |
| >CP Type | M | | ENUMERATED | |
| | | | (normal, extended, . . . ) | |
| >Resource Set | M | | ENUMERATED(4, 5, 8, 10, 16, | |
| Periodicity | | | 20, 32, 40, 64, 80, 160, 320, 640, | |
| | | | 1280, 2560, 5120, 10240, 20480, | |
| | | | 40960, 81920, . . . ) | |
| >Resource Set Slot | M | | INTEGER(0 . . . 81919, . . . ) | |
| Offset | | | | |
| >Resource Repetition | M | | ENUMERATED(rf1, rf2, rf4, | |
| Factor | | | rf6, rf8, rf16, rf32, . . . ) | |
| >Resource Time Gap | M | | ENUMERATED(tg1, tg2, tg4, | |
| | | | tg8, tg16, tg32, . . . ) | |
| >Resource Number | M | | ENUMERATED | |
| of Symbols | | | (n2, n4, n6, n12, . . . ) | |
| >PRS Muting | O | | | |
| >>Option1 | O | | | |
| >>>Muting | M | | 9.2.56 | |
| Pattern | | | | |
| >>>Muting Bit | M | | ENUMERATED(1, 2, 4, 8, . . . ) | |
| Repetition Factor | | | | |
| >>Option2 | O | | | |
| >>>Muting | M | | DL-PRS Muting Pattern | |
| Pattern | | | 9.2.56 | |
| >PRS Resource | M | | INTEGER(−60 . . . 50) | |
| Transmit Power | | | | |
| >PRS Resource List | | 1 | | NR-DL-PRS- |
| | | | | Resource-r16 |
| | | | | defined in TS |
| | | | | 37.355 |
| >>>PRS Resource | | 1 . . . <maxnoofPRSresources> | | |
| Item | | | | |
| >>PRS Resource | M | | INTEGER(0 . . . 63) | |
| ID | | | | |
| >PRS Aggregation | O | | INTEGER(0 . . . X) | |
| ID | | | | |
| >>Sequence ID | M | | INTEGER(0 . . . 4095, . . . ) | |
| >>RE Offset | M | | INTEGER(0 . . . 11) | |
| >>Resource Slot | M | | INTEGER(0 . . . 511, . . . ) | |
| Offset | | | | |
| >>Resource | M | | INTEGER(0 . . . 12, . . . ) | |
| Symbol Offset | | | | |
| >>QCL Info | O | | | |
| >>>QCL Source | O | | INTEGER(0 . . . 63) | |
| SSB Index | | | | |
| >>>QCL Source | O | | | |
| PRS Info | | | | |
| >>>>QCL | M | | INTEGER(0 . . . 7) | |
| Source PRS | | | | |
| Resource Set ID | | | | |
| >>>>QCL | O | | INTEGER(0 . . . 63) | If absent, QCL |
| Source PRS | | | | source PRS |
| Resource ID | | | | resource ID is |
| | | | | same as PRS |
| | | | | resource ID |

In some embodiments, a PRS aggregation ID, TEG ID, or PEG ID may be included with PFL information, indicating that all PRS resources in all PRS resources sets within this PFL are coherently transmitted by a TRP. Note that PRS aggregation ID is an optional parameter in these embodiments, and if not included for a particular PFL, it implies that PRS resources in the PFL cannot be aggregated (e.g., unless PRS aggregation ID is included at another hierarchy level such as PRS resource set or PRS resource).

In some embodiments, a RAN node (e.g., gNB or TRP) indicates DL PRS resources that can be aggregated (e.g., due to a common radio chain and/or Tx PEG) by sending the positioning node a list of PFLs that can be aggregated, which applies to all PRS resources in all PRS resource sets under the listed PFLs.

In other embodiments the positioning node obtains information about associations or mapping between radio chains and groups of carrier frequencies (e.g. PFLs) that can be used for bandwidth aggregated positioning measurements. The association can be the same or different for DL carriers and UL carriers. Each association can indicate a set of carrier frequencies that are provided (e.g., transmitted and/or received) by the RAN node using the same radio chain. Each radio chain can be a TX chain, an RX chain, or a combined TX-RX chain (“transceiver”). Each radio chain can include various physical parameters and/or be associated with various logical entities, such as any of the following:
Antenna port (logical);
Array or set of antenna elements;
Physical antenna;
Power amplifier (PA);
Low noise amplifier (LNA); and
Radio frequency (RF) filter.

To illustrate these embodiments, assume that a RAN node supports multiple carrier groups, G1-Gn, with each group being provided by the RAN node using respective radio chains RC1-RCn. Moreover, the carrier groups may be provided by the RAN node using respective antenna ports P1-Pn. Likewise, each group may include multiple carriers, e.g., (F1,F2) in G1, (F3,F4) in G2, etc. Tables 3-5 below show examples of associations between carrier groups and radio chains, carrier groups and antenna ports, and carriers and antenna ports, respectively, according to various embodiments of the present disclosure.

TABLE 3

| Association ID | Group of carriers | Radio chain |
|---|---|---|
| 1 | G1 | RC1 |
| 2 | G2 | RC2 |
| . . . | . . . | . . . |
| n | Gn | RCn |

TABLE 4

| Association ID | Group of carriers | Antenna port |
|---|---|---|
| 1 | G1 | P1 |
| 2 | G2 | P2 |
| . . . | . . . | . . . |
| n | Gn | Pn |

TABLE 5

| Association ID | Carriers | Antenna port |
|---|---|---|
| 1 | F1, F2 | P1 |
| 2 | F3, F4 | P2 |

When using the same radio chain for providing a group of carriers, the carriers in the group are synchronized, such that they have same or similar phase, same or similar transmit timing, same or similar frequency error relative to a reference frequency, same or similar transmit error relative to a reference timing or clock, etc.

In some embodiments, the RAN node send the information about associations between carrier groups and respective radio chains to the positioning node (e.g. LMF) via NRPPa message.

In some embodiments, the RAN node send the information about associations between carrier groups and respective radio chains to a UE via RRC message. The RAN node can send the associations upon request by the UE, or an indication from the UE that the UE is configured by positioning node to perform a positioning measurements on two or more aggregated carriers. The indication from the UE may include details about the carriers to be aggregated for the positioning measurement. Upon receiving the association information from the RAN node, the UE may send it to the positioning node or use it to determine carriers that it can aggregate for the configured positioning measurement, e.g., carriers associated with a single RAN node radio chain and/or antenna port.

In some embodiments, the association information may include respective identifiers of pre-configured associations. In other embodiments, the association information may include details about carriers (e.g., frequency channel number or identifier, such as ARFCN, NR-ARFCN etc.), radio chains, antenna ports, etc.

Upon receiving the association information from a UE or a RAN node, the positioning node uses the received information to configure the UE with two or more carriers belonging to the same group that can be aggregated for positioning measurements. Once configured in this manner, the UE aggregates PRS resources across the two or more carriers to perform positioning measurements, e.g., RSTD. Aggregation in this manner improves positioning measurement accuracy because PRS across the multiple carriers are synchronized due to being transmitted using the same radio chain and/or antenna port.

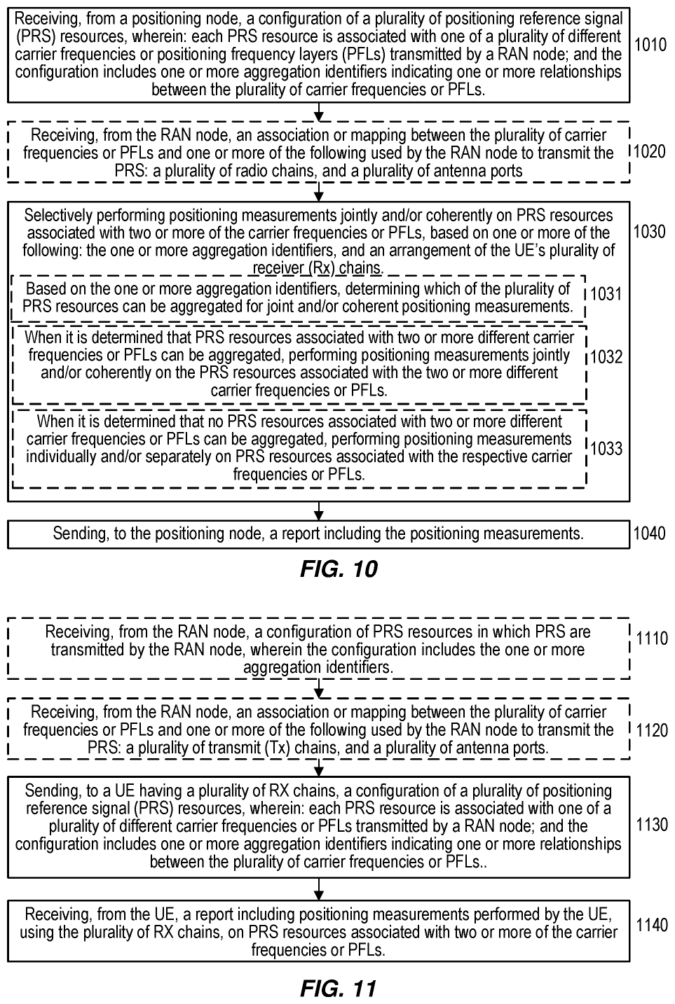

Various features of the embodiments described above correspond to various operations illustrated in FIGS. 10-12, which show exemplary methods (e.g., procedures) for a UE, a positioning node, and a RAN node, respectively. In other words, various features of the operations described below correspond to various embodiments described above. Furthermore, the exemplary methods shown in FIGS. 10-12 can be used cooperatively to provide various benefits, advantages, and/or solutions to problems described herein. Although FIGS. 10-12 show specific blocks in particular orders, the operations of the exemplary methods can be performed in different orders than shown and can be combined and/or divided into blocks having different functionality than shown. Optional blocks or operations are indicated by dashed lines.

In particular, FIG. 10 shows an exemplary method (e.g., procedure) for a UE configured for positioning in a RAN, according to various embodiments of the present disclosure. The exemplary method can be performed by a UE (e.g., wireless device, etc.) such as described elsewhere herein.

The exemplary method can include the operations of block 1010, where the UE can receive, from a positioning node, a configuration of a plurality of PRS resources. Each PRS resource is associated with one of a plurality of different carrier frequencies or positioning frequency layers (PFLs) transmitted by a RAN node. The configuration includes one or more aggregation identifiers indicating one or more relationships between the plurality of carrier frequencies or PFLs.

The exemplary method can also include the operations of block 1030, where the UE can selectively perform positioning measurements jointly and/or coherently on PRS resources associated with two or more of the carrier frequencies or PFLs, based on one or more of the following: the one or more aggregation identifiers, and an arrangement of the UE's plurality of receiver (Rx) chains. The exemplary method can also include the operations of block 1040, where the UE can send to the positioning node a report including the positioning measurements.

In some embodiments, selectively performing positioning measurements jointly and/or coherently in block 1030 includes the following operations, labelled with corresponding sub-block numbers:
(1031) based on the one or more aggregation identifiers, determining which of the plurality of PRS resources can be aggregated for joint and/or coherent positioning measurements;
(1032) when it is determined that PRS resources associated with two or more different carrier frequencies or PFLs can be aggregated, performing positioning measurements jointly and/or coherently on the PRS resources associated with the two or more different carrier frequencies or PFLs; and
(1033) when it is determined that no PRS resources associated with two or more different carrier frequencies or PFLs can be aggregated, performing positioning measurements individually and/or separately on PRS resources associated with the respective carrier frequencies or PFLs.

In some of these embodiments, each of the aggregation identifiers is associated with one or more of the PRS resources, and determining which of the plurality of PRS resources can be aggregated in sub-block 1031 includes the following operations, for each PRS resource:
determining that the PRS resource can be aggregated with other PRS resources associated with the same aggregation identifier as the PRS resource; and
determining that the PRS resource cannot be aggregated with other PRS resources associated with different aggregation identifiers than the PRS resource.

In some of these embodiments, the UE's plurality of receiver (Rx) chains are arranged into a plurality of Rx timing error groups (TEGs) or Rx phase coherence error groups (PEGs). In some variants of these embodiments, determining which of the plurality of PRS resources can be aggregated for joint and/or coherent positioning measurements in sub-block 1031 is further based on which of the plurality of carrier frequencies or PFLs can be received by one of the following: a single Rx chain, or multiple Rx chains that are in a single Rx TEG or Rx PEG.

In some variants of these embodiments, performing positioning measurements jointly and/or coherently on the PRS resources associated with the two or more different carrier frequencies or PFLs in sub-block 1032 includes receiving the two or more different carrier frequencies or PFLs using one of the following: a single Rx chain, or multiple Rx chains that are in a single Rx TEG or Rx PEG.

In some variants of these embodiments, for each positioning measurement, the report includes an identifier of an Rx TEG or a Rx PEG associated with the Rx chain used to perform the positioning measurement.

In some embodiments, the plurality of PRS resources are arranged into one or more PRS resource sets, with each PRS resource set including one or more PRS resources. Also, each aggregation identifier in the configuration is associated with a corresponding one of the following: PRS resource, or PRS resource set.

In some embodiments, the exemplary method also includes the operations of block 1020, where the UE can receive, from the RAN node, an association or mapping between the plurality of carrier frequencies or PFLs and one or more of the following used by the RAN node to transmit the PRS: a plurality of transmitter (Tx) chains, and a plurality of antenna ports.

In some embodiments, the plurality of carrier frequencies or PFLs are transmitted by the RAN node using a plurality of transmitter (Tx) chains, with each of the plurality of Tx chains transmitting at least one of the carrier frequencies or PFLs. Also, the plurality of Tx chains are arranged in a plurality of Tx TEGs or Tx PEGs, with each Tx PEG or Tx TEG including a plurality of Tx chains. Additionally, each aggregation identifier indicates two or more of the carrier frequencies or PFLs transmitted by one of the following: a single Tx chain, or multiple Tx chains in a single Tx PEG or Tx TEG.

In addition, FIG. 11 shows an exemplary method (e.g., procedure) for a positioning node configured to facilitate positioning of UEs operating in a RAN, according to various embodiments of the present disclosure. The exemplary method can be performed by a positioning node (e.g., LMF, E-SMLC, SUPL, etc.) described elsewhere herein.

The exemplary method can include the operations of block 1130, where the positioning node can send, to a UE having a plurality of receiver (Rx) chains, a configuration of a plurality of PRS resources. Each PRS resource is associated with one of a plurality of different carrier frequencies or positioning frequency layers (PFLs) transmitted by a RAN node. The configuration includes one or more aggregation identifiers indicating one or more relationships between the plurality of carrier frequencies or PFLs. The exemplary method can also include the operations of block 1140, where the positioning node can receive from the UE a report including positioning measurements performed by the UE, using the plurality of Rx chains, on PRS resources associated with two or more of the carrier frequencies or PFLs.

In some embodiments, the UE's plurality of receiver (Rx) chains are arranged into a plurality of Rx timing error groups (TEGs) or Rx phase coherence error groups (PEGs). For each positioning measurement, the report includes an identifier of an Rx TEG or an Rx PEG associated with a UE Rx chain used to perform the positioning measurement.

In some of these embodiments, the received positioning measurements include positioning measurements performed jointly and/or coherently on PRS resources associated with two or more different carrier frequencies or PFLs, using one of the following: a single UE Rx chain, or multiple UE Rx chains in a single Rx TEG or Rx PEG.

In other of these embodiments, the received positioning measurements include positioning measurements performed individually and/or separately on PRS resources associated with two or more different carrier frequencies or PFLs.

In some embodiments, the exemplary method can also include the operations of block 1110, where the positioning node can receive from the RAN node a configuration of PRS resources in which PRS are transmitted by the RAN node. The received configuration includes the one or more aggregation identifiers.

In some of these embodiments, the plurality of carrier frequencies or PFLs are transmitted using a plurality of transmitter (Tx) chains, with each of the plurality of Tx chains transmitting at least one of the carrier frequencies or PFLs. Also, the plurality of Tx chains are arranged in a plurality of Tx TEGs or Tx PEGs, with each Tx PEG or Tx TEG including a plurality of Tx chains. Additionally, each aggregation identifier indicates two or more of the carrier frequencies or PFLs transmitted by one of the following: a single Tx chain, or multiple Tx chains in a single Tx PEG or Tx TEG.

In some embodiments, the exemplary method can also include the operations of block 1120, where the positioning node can receive from the RAN node an association or mapping between the plurality of carrier frequencies or PFLs and one or more of the following used by the RAN node to transmit the PRS: a plurality of Tx chains, and a plurality of antenna ports.

In some embodiments, the plurality of PRS resources are arranged into one or more PRS resource sets, with each PRS resource set including one or more PRS resources. Also, each aggregation identifier in the configuration is associated with a corresponding one of the following: PRS resource, or PRS resource set.

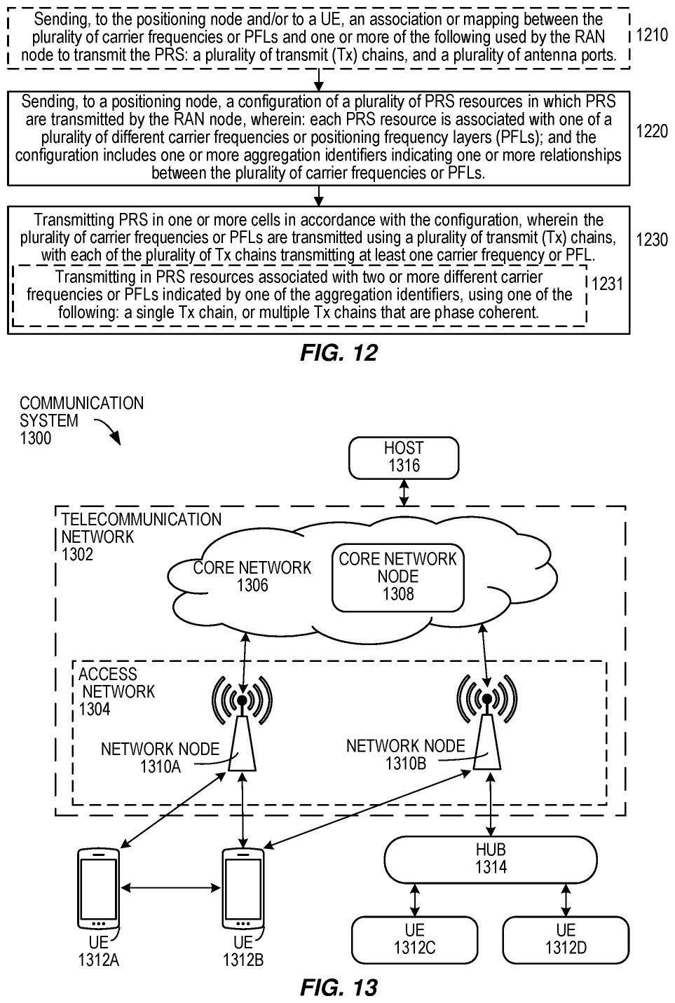

In addition, FIG. 12 shows an exemplary method (e.g., procedure) for a RAN node configured to support positioning of UEs in the RAN, according to various embodiments of the present disclosure. The exemplary method can be performed by a network node (e.g., base station, eNB, gNB, ng-eNB, TRP, etc.) such as described elsewhere herein.

The exemplary method includes the operations of block 1220, where the RAN node can send, to a positioning node, a configuration of a plurality of PRS resources in which PRS are transmitted by the RAN node. Each PRS resource is associated with one of a plurality of different carrier frequencies or PFLs. The configuration includes one or more aggregation identifiers indicating one or more relationships between the plurality of carrier frequencies or PFLs. The exemplary method also includes the operations of block 1230, where the RAN node can transmit PRS in one or more cells according to the configuration. The plurality of carrier frequencies or PFLs are transmitted using a plurality of transmitter (Tx) chains, with each of the plurality of Tx chains transmitting at least one of the carrier frequencies or PFLs.

In some embodiments, the plurality of Tx chains are arranged in a plurality of Tx timing error groups (TEGs) or Tx phase coherence error groups (PEGs), with each Tx PEG or Tx TEG including a plurality of Tx chains. In some of these embodiments, each aggregation identifier indicates two or more of the carrier frequencies or PFLs transmitted by one of the following: a single Tx chain, or multiple Tx chains in a single Tx PEG or Tx TEG.

In some embodiments, transmitting PRS in one or more cells in accordance with the configuration in block 1230 includes the operations of sub-block 1231, where the RAN node can transmit in PRS resources associated with two or more different carrier frequencies or PFLs indicated by one of the aggregation identifiers, using one of the following: a single Tx chain, or multiple Tx chains that are phase coherent.

In some embodiments, the exemplary method can also include the operations of block 1210, where the RAN node can send, to the positioning node and/or to a UE, an association or mapping between the plurality of carrier frequencies or PFLs and one or more of the following used by the RAN node to transmit the PRS: the plurality of Tx chains, and a plurality of antenna ports.

In some embodiments, the plurality of PRS resources are arranged into one or more PRS resource sets, with each PRS resource set including one or more PRS resources. Also, each aggregation identifier is associated with a corresponding one of the following: PRS resource, or PRS resource set.

Although various embodiments are described above in terms of methods, techniques, and/or procedures, the person of ordinary skill will readily comprehend that such methods, techniques, and/or procedures can be embodied by various combinations of hardware and software in various systems, communication devices, computing devices, control devices, apparatuses, non-transitory computer-readable media, computer program products, etc.

FIG. 13 shows an example of a communication system 1300 in accordance with some embodiments. In this example, communication system 1300 includes telecommunication network 1302 that includes access network 1304 (e.g., RAN) and a core network 1306, which includes one or more core network nodes 1308. Access network 1304 includes one or more access network nodes, such as network nodes 1310a-b (one or more of which may be generally referred to as network nodes 1310), or any other similar 3GPP access node or non-3GPP access point. Network nodes 1310 facilitate direct or indirect connection of UEs, such as by connecting UEs 1312a-d (one or more of which may be generally referred to as UEs 1312) to core network 1306 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, communication system 1300 may include any number of wired or wireless networks, network nodes, UEs, and/or any other components or systems that may facilitate or participate in the communication of data and/or signals whether via wired or wireless connections. Communication system 1300 may include and/or interface with any type of communication, telecommunication, data, cellular, radio network, and/or other similar type of system.

UEs 1312 may be any of a wide variety of communication devices, including wireless devices arranged, configured, and/or operable to communicate wirelessly with network nodes 1310 and other communication devices. Similarly, network nodes 1310 are arranged, capable, configured, and/or operable to communicate directly or indirectly with UEs 1312 and/or with other network nodes or equipment in telecommunication network 1302 to enable and/or provide network access, such as wireless network access, and/or to perform other functions, such as administration in telecommunication network 1302.

In the depicted example, core network 1306 connects network nodes 1310 to one or more hosts, such as host 1316. These connections may be direct or indirect via one or more intermediary networks or devices. In other examples, network nodes may be directly coupled to hosts. Core network 1306 includes one or more core network nodes (e.g., 1308) that are structured with hardware and software components. Features of these components may be substantially similar to those described with respect to the UEs, network nodes, and/or hosts, such that the descriptions thereof are generally applicable to the corresponding components of core network node 1308. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-concealing function (SIDF), Unified Data Management (UDM), Security Edge Protection Proxy (SEPP), Network Exposure Function (NEF), Location Management Function (LMF), Enhanced Serving Mobile Location Center (E-SMLC), SUPL Location Platform (SLP), and/or a User Plane Function (UPF).

Host 1316 may be under the ownership or control of a service provider other than an operator or provider of access network 1304 and/or telecommunication network 1302, and may be operated by the service provider or on behalf of the service provider. Host 1316 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, communication system 1300 of FIG. 13 enables connectivity between the UEs, network nodes, and hosts. In that sense, the communication system may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable 2G, 3G, 4G, 5G standards, or any applicable future generation standard (e.g., 6G); wireless local area network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any low-power wide-area network (LPWAN) standards such as LoRa and Sigfox.

In some examples, telecommunication network 1302 is a cellular network that implements 3GPP standardized features. Accordingly, telecommunication network 1302 may support network slicing to provide different logical networks to different devices that are connected to telecommunication network 1302. For example, telecommunication network 1302 may provide Ultra Reliable Low Latency Communication (URLLC) services to some UEs, while providing Enhanced Mobile Broadband (eMBB) services to other UEs, and/or Massive Machine Type Communication (mMTC)/Massive IoT services to yet further UEs.

In some examples, UEs 1312 are configured to transmit and/or receive information without direct human interaction. For instance, a UE may be designed to transmit information to access network 1304 on a predetermined schedule, when triggered by an internal or external event, or in response to requests from access network 1304. Additionally, a UE may be configured for operating in single- or multi-RAT or multi-standard mode. For example, a UE may operate with any one or combination of Wi-Fi, NR (New Radio) and LTE, i.e., being configured for multi-radio dual connectivity (MR-DC), such as E-UTRAN (Evolved-UMTS Terrestrial Radio Access Network) New Radio-Dual Connectivity (EN-DC).

In the example, hub 1314 communicates with access network 1304 to facilitate indirect communication between one or more UEs (e.g., 1312c and/or 1312d) and network nodes (e.g., 1310b). In some examples, hub 1314 may be a controller, router, content source and analytics, or any of the other communication devices described herein regarding UEs. For example, hub 1314 may be a broadband router enabling access to core network 1306 for the UEs. As another example, hub 1314 may be a controller that sends commands or instructions to one or more actuators in the UEs. Commands or instructions may be received from the UEs, network nodes 1310, or by executable code, script, process, or other instructions in hub 1314. As another example, hub 1314 may be a data collector that acts as temporary storage for UE data and, in some embodiments, may perform analysis or other processing of the data. As another example, hub 1314 may be a content source. For example, for a UE that is a VR headset, display, loudspeaker or other media delivery device, hub 1314 may retrieve VR assets, video, audio, or other media or data related to sensory information via a network node, which hub 1314 then provides to the UE either directly, after performing local processing, and/or after adding additional local content. In still another example, hub 1314 acts as a proxy server or orchestrator for the UEs, in particular in if one or more of the UEs are low energy IoT devices.

Hub 1314 may have a constant/persistent or intermittent connection to network node 1310b. Hub 1314 may also allow for a different communication scheme and/or schedule between hub 1314 and UEs (e.g., 1312c and/or 1312d), and between hub 1314 and core network 1306. In other examples, hub 1314 is connected to core network 1306 and/or one or more UEs via a wired connection. Moreover, hub 1314 may be configured to connect to an M2M service provider over access network 1304 and/or to another UE over a direct connection. In some scenarios, UEs may establish a wireless connection with network nodes 1310 while still connected via hub 1314 via a wired or wireless connection. In some embodiments, hub 1314 may be a dedicated hub—that is, a hub whose primary function is to route communications to/from the UEs from/to network node 1310b. In other embodiments, hub 1314 may be a non-dedicated hub—that is, a device that can route communications between the UEs and network node 1310b, but which also can be a communication start and/or end point for certain data channels.

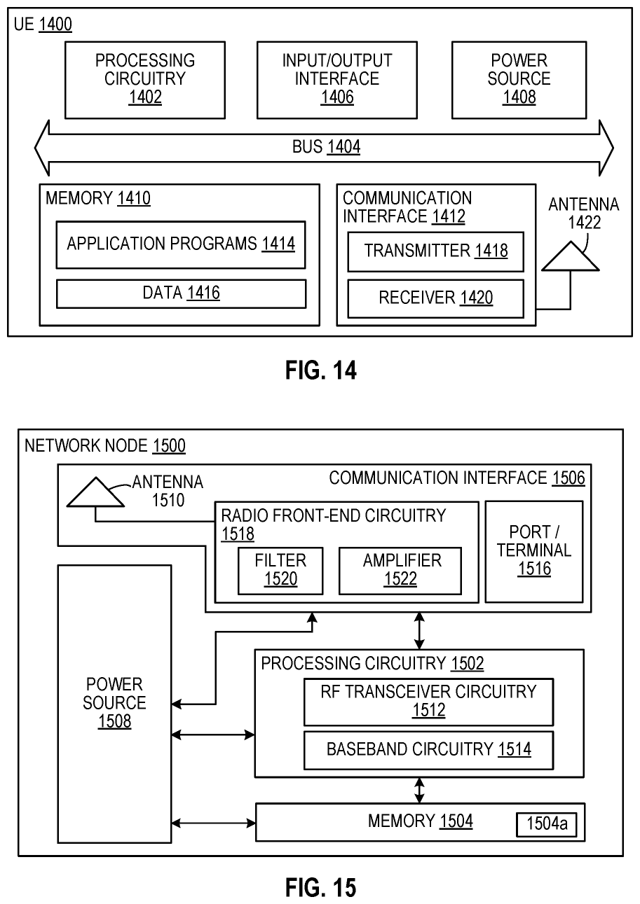

FIG. 14 shows a UE 1400 in accordance with some embodiments. Examples of a UE include, but are not limited to, a smart phone, mobile phone, cell phone, voice over IP (VoIP) phone, wireless local loop phone, desktop computer, personal digital assistant (PDA), wireless cameras, gaming console or device, music storage device, playback appliance, wearable terminal device, wireless endpoint, mobile station, tablet, laptop, laptop-embedded equipment (LEE), laptop-mounted equipment (LME), smart device, wireless customer-premise equipment (CPE), vehicle-mounted or vehicle embedded/integrated wireless device, etc. Other examples include any UE identified by 3GPP, including a narrow band internet of things (NB-IoT) UE, a machine type communication (MTC) UE, and/or an enhanced MTC (eMTC) UE.

A UE may support device-to-device (D2D) communication, for example by implementing a 3GPP standard for sidelink communication, Dedicated Short-Range Communication (DSRC), vehicle-to-vehicle (V2V), vehicle-to-infrastructure (V2I), or vehicle-to-everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

UE 1400 includes processing circuitry 1402 that is operatively coupled via bus 1404 to input/output interface 1406, power source 1408, memory 1410, communication interface 1412, and possibly other components not shown. Certain UEs may utilize all or a subset of the components shown in FIG. 14. The level of integration between the components may vary from one UE to another UE. Further, certain UEs may contain multiple instances of a component, such as multiple processors, memories, transceivers, transmitters, receivers, etc.

Processing circuitry 1402 is configured to process instructions and data and may be configured to implement any sequential state machine operative to execute instructions stored as machine-readable computer programs in memory 1410. Processing circuitry 1402 may be implemented as one or more hardware-implemented state machines (e.g., in discrete logic, field-programmable gate arrays (FPGAs), application specific integrated circuits (ASICs), etc.); programmable logic together with appropriate firmware; one or more stored computer programs, general-purpose processors, such as a microprocessor or digital signal processor (DSP), together with appropriate software; or any combination of the above. For example, processing circuitry 1402 may include multiple central processing units (CPUs).

In the example, input/output interface 1406 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof Δn input device may allow a user to capture information into UE 1400. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, power source 1408 is structured as a battery or battery pack. Other types of power sources, such as an external power source (e.g., an electricity outlet), photovoltaic device, or power cell, may be used. Power source 1408 may further include power circuitry for delivering power from power source 1408 itself, and/or an external power source, to the various parts of UE 1400 via input circuitry or an interface such as an electrical power cable. Delivering power may be, for example, for charging of power source 1408. Power circuitry may perform any formatting, converting, or other modification to the power from power source 1408 to make the power suitable for the respective components of UE 1400 to which power is supplied.

Memory 1410 may be or be configured to include memory such as random access memory (RAM), read-only memory (ROM), programmable read-only memory (PROM), erasable programmable read-only memory (EPROM), electrically erasable programmable read-only memory (EEPROM), magnetic disks, optical disks, hard disks, removable cartridges, flash drives, and so forth. In one example, memory 1410 includes one or more application programs 1414, such as an operating system, web browser application, a widget, gadget engine, or other application, and corresponding data 1416. Memory 1410 may store, for use by UE 1400, any of a variety of various operating systems or combinations of operating systems.

Memory 1410 may be configured to include a number of physical drive units, such as redundant array of independent disks (RAID), flash memory, USB flash drive, external hard disk drive, thumb drive, pen drive, key drive, high-density digital versatile disc (HD-DVD) optical disc drive, internal hard disk drive, Blu-Ray optical disc drive, holographic digital data storage (HDDS) optical disc drive, external mini-dual in-line memory module (DIMM), synchronous dynamic random access memory (SDRAM), external micro-DIMM SDRAM, smartcard memory such as tamper resistant module in the form of a universal integrated circuit card (UICC) including one or more subscriber identity modules (SIMs), such as a USIM and/or ISIM, other memory, or any combination thereof. The UICC may for example be an embedded UICC (eUICC), integrated UICC (iUICC) or a removable UICC commonly known as ‘SIM card.’ Memory 1410 may allow UE 1400 to access instructions, application programs and the like, stored on transitory or non-transitory memory media, to off-load data, or to upload data. An article of manufacture, such as one utilizing a communication system may be tangibly embodied as or in memory 1410, which may be or comprise a device-readable storage medium.

Processing circuitry 1402 may be configured to communicate with an access network or other network using communication interface 1412. Communication interface 1412 may comprise one or more communication subsystems and may include or be communicatively coupled to an antenna 1422. Communication interface 1412 may include one or more transceivers used to communicate, such as by communicating with one or more remote transceivers of another device capable of wireless communication (e.g., another UE or a network node in an access network). Each transceiver may include transmitter 1418 and/or receiver 1420 appropriate to provide network communications (e.g., optical, electrical, frequency allocations, and so forth). Moreover, transmitter 1418 and/or receiver 1420 may be coupled to one or more antennas (e.g., 1422) and may share circuit components, software, and/or firmware, or alternatively be implemented separately.

In the illustrated embodiment, communication functions of communication interface 1412 may include cellular communication, Wi-Fi communication, LPWAN communication, data communication, voice communication, multimedia communication, short-range communications such as Bluetooth, near-field communication, location-based communication such as the use of the global positioning system (GPS) to determine a location, another like communication function, or any combination thereof. Communications may be implemented in according to one or more communication protocols and/or standards, such as IEEE 802.11, Code Division Multiplexing Access (CDMA), Wideband Code Division Multiple Access (WCDMA), GSM, LTE, New Radio (NR), UMTS, WiMax, Ethernet, transmission control protocol/internet protocol (TCP/IP), synchronous optical networking (SONET), Asynchronous Transfer Mode (ATM), QUIC, Hypertext Transfer Protocol (HTTP), and so forth.

Regardless of the type of sensor, a UE may provide an output of data captured by its sensors, through its communication interface 1412, via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., an alert is sent when moisture is detected), in response to a request (e.g., a user initiated request), or a continuous stream (e.g., a live video feed of a patient).

As another example, a UE comprises an actuator, a motor, or a switch, related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an Internet of Things (IoT) device, may be a device for use in one or more application domains, these domains comprising, but not limited to, city wearable technology, extended industrial application and healthcare. Non-limiting examples of such an IoT device are a device which is or which is embedded in: a connected refrigerator or freezer, a TV, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or Virtual Reality (VR), a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to UE 1400 shown in FIG. 14.

As yet another specific example, in an IoT scenario, a UE may represent a machine or other device that performs monitoring and/or measurements, and transmits the results of such monitoring and/or measurements to another UE and/or a network node. The UE may in this case be an M2M device, which may implement the 3GPP NB-IoT standard and/or be referred to as an MTC device. In other scenarios, a UE may represent a vehicle, such as a car, a bus, a truck, a ship and an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator, and handle communication of data for both the speed sensor and the actuators.

FIG. 15 shows a network node 1500 in accordance with some embodiments. Examples of network nodes include, but are not limited to, access points (e.g., radio access points) and base stations (e.g., radio base stations, Node Bs, eNBs, and gNBs).

Base stations may be categorized based on the amount of coverage they provide (or, stated differently, their transmit power level) and so, depending on the provided amount of coverage, may be referred to as femto base stations, pico base stations, micro base stations, or macro base stations. A base station may be a relay node or a relay donor node controlling a relay. A network node may also include one or more (or all) parts of a distributed radio base station such as centralized digital units and/or remote radio units (RRUs), sometimes referred to as Remote Radio Heads (RRHs). Such remote radio units may or may not be integrated with an antenna as an antenna integrated radio. Parts of a distributed radio base station may also be referred to as nodes in a distributed antenna system (DAS).

Other examples of network nodes include multiple transmission point (multi-TRP) 5G access nodes, multi-standard radio (MSR) equipment such as MSR BSs, network controllers such as radio network controllers (RNCs) or base station controllers (BSCs), base transceiver stations (BTSs), transmission points, transmission nodes, multi-cell/multicast coordination entities (MCEs), Operation and Maintenance (O&M) nodes, Operations Support System (OSS) nodes, Self-Organizing Network (SON) nodes, positioning nodes (e.g., LMFs, E-SMLCs, SLPs, etc.), and/or Minimization of Drive Tests (MDTs).

Network node 1500 includes processing circuitry 1502, memory 1504, communication interface 1506, and power source 1508. Network node 1500 may be composed of multiple physically separate components (e.g., a NodeB component and a RNC component, or a BTS component and a BSC component, etc.), which may each have their own respective components. In certain scenarios in which network node 1500 comprises multiple separate components (e.g., BTS and BSC components), one or more of the separate components may be shared among several network nodes. For example, a single RNC may control multiple NodeBs. In such a scenario, each unique NodeB and RNC pair, may in some instances be considered a single separate network node. In some embodiments, network node 1500 may be configured to support multiple radio access technologies (RATs). In such embodiments, some components may be duplicated (e.g., separate memory for different RATs) and some components may be reused (e.g., a single antenna may be shared by different RATs). Network node 1500 may also include multiple sets of the various illustrated components for different wireless technologies integrated into network node 1500, for example GSM, WCDMA, LTE, NR, WiFi, Zigbee, Z-wave, LoRaWAN, Radio Frequency Identification (RFID) or Bluetooth wireless technologies. These wireless technologies may be integrated into the same or different chip or set of chips and other components within network node 1500.

Processing circuitry 1502 may comprise a combination of one or more of a microprocessor, controller, microcontroller, central processing unit, digital signal processor, application-specific integrated circuit, field programmable gate array, or any other suitable computing device, resource, or combination of hardware, software and/or encoded logic operable to provide, either alone or in conjunction with other network node 1500 components, such as memory 1504, to provide network node 1500 functionality.

In some embodiments, processing circuitry 1502 includes a system on a chip (SOC). In some embodiments, processing circuitry 1502 includes one or more of radio frequency (RF) transceiver circuitry 1512 and baseband processing circuitry 1514. In some embodiments, RF transceiver circuitry 1512 and baseband processing circuitry 1514 may be on separate chips (or sets of chips), boards, or units, such as radio units and digital units. In alternative embodiments, part or all of RF transceiver circuitry 1512 and baseband processing circuitry 1514 may be on the same chip or set of chips, boards, or units.

Memory 1504 may comprise any form of volatile or non-volatile computer-readable memory including, without limitation, persistent storage, solid-state memory, remotely mounted memory, magnetic media, optical media, random access memory (RAM), read-only memory (ROM), mass storage media (for example, a hard disk), removable storage media (for example, a flash drive, a Compact Disk (CD) or a Digital Video Disk (DVD)), and/or any other volatile or non-volatile, non-transitory device-readable and/or computer-executable memory devices that store information, data, and/or instructions that may be used by processing circuitry 1502. Memory 1504 may store any suitable instructions, data, or information, including a computer program, software, an application including one or more of logic, rules, code, tables, and/or other instructions (collectively denoted computer program 1504a, which may be in the form of a computer program product) capable of being executed by processing circuitry 1502 and utilized by network node 1500. Memory 1504 may be used to store any calculations made by processing circuitry 1502 and/or any data received via communication interface 1506. In some embodiments, processing circuitry 1502 and memory 1504 is integrated.

Communication interface 1506 is used in wired or wireless communication of signaling and/or data between a network node, access network, and/or UE. As illustrated, communication interface 1506 comprises port(s)/terminal(s) 1516 to send and receive data, for example to and from a network over a wired connection. Communication interface 1506 also includes radio front-end circuitry 1518 that may be coupled to, or in certain embodiments a part of, antenna 1510. Radio front-end circuitry 1518 comprises filters 1520 and amplifiers 1522. Radio front-end circuitry 1518 may be connected to an antenna 1510 and processing circuitry 1502. The radio front-end circuitry may be configured to condition signals communicated between antenna 1510 and processing circuitry 1502. Radio front-end circuitry 1518 may receive digital data that is to be sent out to other network nodes or UEs via a wireless connection. Radio front-end circuitry 1518 may convert the digital data into a radio signal having the appropriate channel and bandwidth parameters using a combination of filters 1520 and/or amplifiers 1522. The radio signal may then be transmitted via antenna 1510. Similarly, when receiving data, antenna 1510 may collect radio signals which are then converted into digital data by radio front-end circuitry 1518. The digital data may be passed to processing circuitry 1502. In other embodiments, the communication interface may comprise different components and/or different combinations of components.

In certain alternative embodiments, network node 1500 does not include separate radio front-end circuitry 1518, instead, processing circuitry 1502 includes radio front-end circuitry and is connected to antenna 1510. Similarly, in some embodiments, all or some of RF transceiver circuitry 1512 is part of communication interface 1506. In still other embodiments, communication interface 1506 includes one or more ports or terminals 1516, radio front-end circuitry 1518, and RF transceiver circuitry 1512, as part of a radio unit (not shown), and communication interface 1506 communicates with baseband processing circuitry 1514, which is part of a digital unit (not shown).

Antenna 1510 may include one or more antennas, or antenna arrays, configured to send and/or receive wireless signals. Antenna 1510 may be coupled to radio front-end circuitry 1518 and may be any type of antenna capable of transmitting and receiving data and/or signals wirelessly. In certain embodiments, antenna 1510 is separate from network node 1500 and connectable to network node 1500 through an interface or port.

Antenna 1510, communication interface 1506, and/or processing circuitry 1502 may be configured to perform any receiving operations and/or certain obtaining operations described herein as being performed by the network node. Any information, data and/or signals may be received from a UE, another network node and/or any other network equipment. Similarly, antenna 1510, communication interface 1506, and/or processing circuitry 1502 may be configured to perform any transmitting operations described herein as being performed by the network node. Any information, data and/or signals may be transmitted to a UE, another network node and/or any other network equipment.

Power source 1508 provides power to the various components of network node 1500 in a form suitable for the respective components (e.g., at a voltage and current level needed for each respective component). Power source 1508 may further comprise, or be coupled to, power management circuitry to supply the components of network node 1500 with power for performing the functionality described herein. For example, network node 1500 may be connectable to an external power source (e.g., the power grid, an electricity outlet) via an input circuitry or interface such as an electrical cable, whereby the external power source supplies power to power circuitry of power source 1508. As a further example, power source 1508 may comprise a source of power in the form of a battery or battery pack which is connected to, or integrated in, power circuitry. The battery may provide backup power should the external power source fail.

Embodiments of network node 1500 may include additional components beyond those shown in FIG. 15 for providing certain aspects of the network node's functionality, including any of the functionality described herein and/or any functionality necessary to support the subject matter described herein. For example, network node 1500 may include user interface equipment to allow input of information into network node 1500 and to allow output of information from network node 1500. This may allow a user to perform diagnostic, maintenance, repair, and other administrative functions for network node 1500.

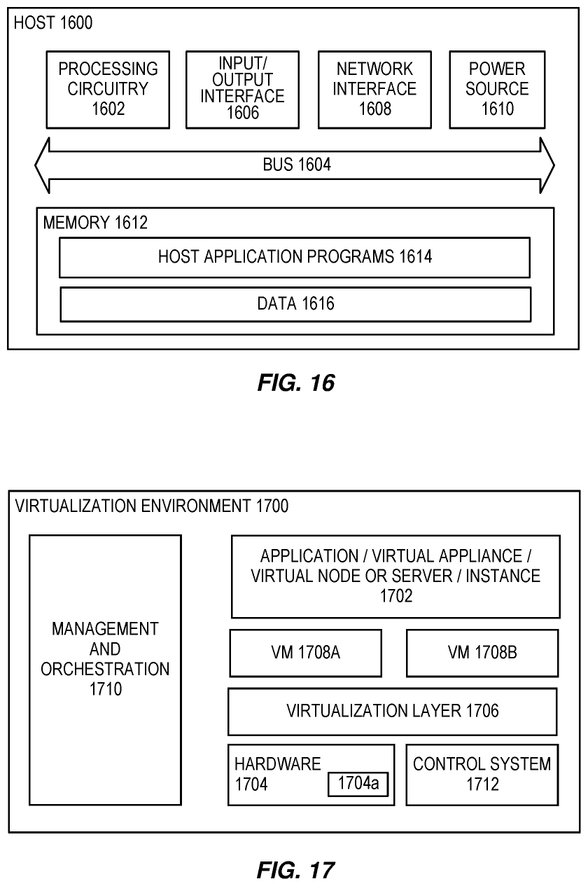

FIG. 16 is a block diagram of a host 1600, which may be an embodiment of host 1316 of FIG. 13, in accordance with various aspects described herein. As used herein, host 1600 may be or comprise various combinations hardware and/or software, including a standalone server, a blade server, a cloud-implemented server, a distributed server, a virtual machine, container, or processing resources in a server farm. Host 1600 may provide one or more services to one or more UEs.

Host 1600 includes processing circuitry 1602 that is operatively coupled via bus 1604 to input/output interface 1606, network interface 1608, power source 1610, and memory 1612. Other components may be included in other embodiments. Features of these components may be substantially similar to those described with respect to the devices of previous figures, such as FIGS. 14 and 15, such that the descriptions thereof are generally applicable to the corresponding components of host 1600.

Memory 1612 may include one or more computer programs including one or more host application programs 1614 and data 1616, which may include user data, e.g., data generated by a UE for host 1600 or data generated by host 1600 for a UE. Embodiments of host 1600 may utilize only a subset or all of the components shown. Host application programs 1614 may be implemented in a container-based architecture and may provide support for video codecs (e.g., Versatile Video Coding (VVC), High Efficiency Video Coding (HEVC), Advanced Video Coding (AVC), MPEG, VP9) and audio codecs (e.g., FLAC, Advanced Audio Coding (AAC), MPEG, G.711), including transcoding for multiple different classes, types, or implementations of UEs (e.g., handsets, desktop computers, wearable display systems, heads-up display systems). Host application programs 1614 may also provide for user authentication and licensing checks and may periodically report health, routes, and content availability to a central node, such as a device in or on the edge of a core network. Accordingly, host 1600 may select and/or indicate a different host for over-the-top services for a UE. Host application programs 1614 may support various protocols, such as the HTTP Live Streaming (HLS) protocol, Real-Time Messaging Protocol (RTMP), Real-Time Streaming Protocol (RTSP), Dynamic Adaptive Streaming over HTTP (MPEG-DASH), etc.

FIG. 17 is a block diagram illustrating a virtualization environment 1700 in which functions implemented by some embodiments may be virtualized. In the present context, virtualizing means creating virtual versions of apparatuses or devices which may include virtualizing hardware platforms, storage devices and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more virtual machines (VMs) implemented in virtualization environment 1700 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1702 (which may alternatively be called software instances, virtual appliances, network functions, virtual nodes, virtual network functions, etc.) are run in virtualization environment 1600 to implement some of the features, functions, and/or benefits of various embodiments disclosed herein.

Hardware 1704 includes processing circuitry, memory that stores software and/or instructions (collectively denoted computer program 1704a, which may be in the form of a computer program product) executable by hardware processing circuitry, and/or other hardware devices as described herein, such as a network interface, input/output interface, and so forth. Software may be executed by the processing circuitry to instantiate one or more virtualization layers 1706 (also referred to as hypervisors or virtual machine monitors (VMMs)), provide VMs 1708a-b (one or more of which may be generally referred to as VMs 1708), and/or perform any of the functions, features and/or benefits described in relation with some embodiments described herein. Virtualization layer 1706 may present a virtual operating platform that appears like networking hardware to VMs 1708.

VMs 1708 comprise virtual processing, virtual memory, virtual networking or interface and virtual storage, and may be run by a corresponding virtualization layer 1706. Different embodiments of the instance of a virtual appliance 1702 may be implemented on one or more of VMs 1708, and the implementations may be made in different ways. Virtualization of the hardware is in some contexts referred to as network function virtualization (NFV). NFV may be used to consolidate many network equipment types onto industry standard high volume server hardware, physical switches, and physical storage, which can be located in data centers, and customer premise equipment.

In the context of NFV, each VM 1708 may be a software implementation of a physical machine that runs programs as if they were executing on a physical, non-virtualized machine. Each VM 1708, and that part of hardware 1704 that executes that VM, be it hardware dedicated to that VM and/or hardware shared by that VM with others of the VMs, forms separate virtual network elements. Still in the context of NFV, a virtual network function is responsible for handling specific network functions that run in VMs 1708 on top of hardware 1704 and correspond to application 1702.

Hardware 1704 may be implemented in a standalone network node with generic or specific components. Hardware 1704 may implement some functions via virtualization. Alternatively, hardware 1704 may be part of a larger cluster of hardware (e.g., such as in a data center or CPE) where many hardware nodes work together and are managed via management and orchestration 1710, which, among others, oversees lifecycle management of applications 1702. In some embodiments, hardware 1704 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a radio access node or a base station. In some embodiments, some signaling can be provided with the use of control system 1712 which may alternatively be used for communication between hardware nodes and radio units.

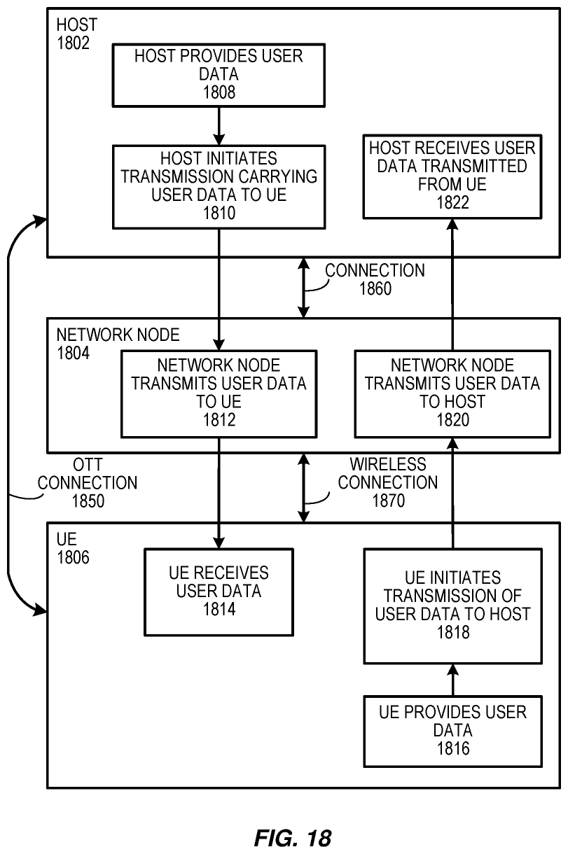

FIG. 18 shows a communication diagram of a host 1802 communicating via a network node 1804 with a UE 1806 over a partially wireless connection in accordance with some embodiments. Example implementations, in accordance with various embodiments, of the UE (such as a UE 1312a of FIG. 13 and/or UE 1400 of FIG. 14), network node (such as network node 1310a of FIG. 13 and/or network node 1500 of FIG. 15), and host (such as host 1316 of FIG. 13 and/or host 1600 of FIG. 16) discussed in the preceding paragraphs will now be described with reference to FIG. 18.

Like host 1600, embodiments of host 1802 include hardware, such as a communication interface, processing circuitry, and memory. Host 1802 also includes software, which is stored in or accessible by host 1802 and executable by the processing circuitry. The software includes a host application that may be operable to provide a service to a remote user, such as UE 1806 connecting via an over-the-top (OTT) connection 1850 extending between UE 1806 and host 1802. In providing the service to the remote user, a host application may provide user data which is transmitted using OTT connection 1850.

Network node 1804 includes hardware enabling it to communicate with host 1802 and UE 1806. Connection 1860 may be direct or pass through a core network (like core network 1306 of FIG. 13) and/or one or more other intermediate networks, such as one or more public, private, or hosted networks. For example, an intermediate network may be a backbone network or the Internet.

UE 1806 includes hardware and software, which is stored in or accessible by UE 1806 and executable by the UE's processing circuitry. The software includes a client application, such as a web browser or operator-specific “app” that may be operable to provide a service to a human or non-human user via UE 1806 with the support of host 1802. In host 1802, an executing host application may communicate with the executing client application via OTT connection 1850 terminating at UE 1806 and host 1802. In providing the service to the user, the UE's client application may receive request data from the host's host application and provide user data in response to the request data. OTT connection 1850 may transfer both the request data and the user data. The UE's client application may interact with the user to generate the user data that it provides to the host application through OTT connection 1850.

OTT connection 1850 may extend via a connection 1860 between host 1802 and network node 1804 and via a wireless connection 1870 between network node 1804 and UE 1806 to provide the connection between host 1802 and UE 1806. Connection 1860 and wireless connection 1870, over which OTT connection 1850 may be provided, have been drawn abstractly to illustrate the communication between host 1802 and UE 1806 via network node 1804, without explicit reference to any intermediary devices and the precise routing of messages via these devices.

As an example of transmitting data via OTT connection 1850, in step 1808, host 1802 provides user data, which may be performed by executing a host application. In some embodiments, the user data is associated with a particular human user interacting with UE 1806. In other embodiments, the user data is associated with a UE 1806 that shares data with host 1802 without explicit human interaction. In step 1810, host 1802 initiates a transmission carrying the user data towards UE 1806. Host 1802 may initiate the transmission responsive to a request transmitted by UE 1806. The request may be caused by human interaction with UE 1806 or by operation of the client application executing on UE 1806. The transmission may pass via network node 1804, in accordance with the teachings of the embodiments described throughout this disclosure. Accordingly, in step 1812, network node 1804 transmits to UE 1806 the user data that was carried in the transmission that host 1802 initiated, in accordance with the teachings of the embodiments described throughout this disclosure. In step 1814, UE 1806 receives the user data carried in the transmission, which may be performed by a client application executed on UE 1806 associated with the host application executed by host 1802.

In some examples, UE 1806 executes a client application which provides user data to host 1802. The user data may be provided in reaction or response to the data received from host 1802. Accordingly, in step 1816, UE 1806 may provide user data, which may be performed by executing the client application. In providing the user data, the client application may further consider user input received from the user via an input/output interface of UE 1806. Regardless of the specific manner in which the user data was provided, UE 1806 initiates, in step 1818, transmission of the user data towards host 1802 via network node 1804. In step 1820, in accordance with the teachings of the embodiments described throughout this disclosure, network node 1804 receives user data from UE 1806 and initiates transmission of the received user data towards host 1802. In step 1822, host 1802 receives the user data carried in the transmission initiated by UE 1806.

One or more of the various embodiments improve the performance of OTT services provided to UE 1806 using OTT connection 1850, in which wireless connection 1870 forms the last segment. More precisely, embodiments can facilitate UE bandwidth aggregation (e.g., multiple carriers/PFLs) for positioning measurements and network knowledge of such UE bandwidth aggregation, thereby enabling the use of bandwidth-aggregated positioning measurements to increase positioning accuracy and/or precision. In this manner, embodiments can improve the delivery of positioning-based OTT services by a wireless network (including the RAN), which increases the value of such services to end users and OTT service providers.

In an example scenario, factory status information may be collected and analyzed by host 1802. As another example, host 1802 may process audio and video data which may have been retrieved from a UE for use in creating maps. As another example, host 1802 may collect and analyze real-time data to assist in controlling vehicle congestion (e.g., controlling traffic lights). As another example, host 1802 may store surveillance video uploaded by a UE. As another example, host 1802 may store or control access to media content such as video, audio, VR or AR which it can broadcast, multicast or unicast to UEs. As other examples, host 1802 may be used for energy pricing, remote control of non-time critical electrical load to balance power generation needs, location services, presentation services (such as compiling diagrams etc. from data collected from remote devices), or any other function of collecting, retrieving, storing, analyzing and/or transmitting data.

In some examples, a measurement procedure may be provided for the purpose of monitoring data rate, latency and other factors on which the one or more embodiments improve. There may further be an optional network functionality for reconfiguring OTT connection 1850 between host 1802 and UE 1806, in response to variations in the measurement results. The measurement procedure and/or the network functionality for reconfiguring the OTT connection may be implemented in software and hardware of host 1802 and/or UE 1806. In some embodiments, sensors (not shown) may be deployed in or in association with other devices through which OTT connection 1850 passes; the sensors may participate in the measurement procedure by supplying values of the monitored quantities exemplified above, or supplying values of other physical quantities from which software may compute or estimate the monitored quantities. The reconfiguring of OTT connection 1850 may include message format, retransmission settings, preferred routing etc.; the reconfiguring need not directly alter the operation of network node 1804. Such procedures and functionalities may be known and practiced in the art. In certain embodiments, measurements may involve proprietary UE signaling that facilitates measurements of throughput, propagation times, latency and the like, by host 1802. The measurements may be implemented in that software causes messages to be transmitted, in particular empty or ‘dummy’ messages, using OTT connection 1850 while monitoring propagation times, errors, etc.

The foregoing merely illustrates the principles of the disclosure. Various modifications and alterations to the described embodiments will be apparent to those skilled in the art in view of the teachings herein. It will thus be appreciated that those skilled in the art will be able to devise numerous systems, arrangements, and procedures that, although not explicitly shown or described herein, embody the principles of the disclosure and can be thus within the spirit and scope of the disclosure. Various exemplary embodiments can be used together with one another, as well as interchangeably therewith, as should be understood by those having ordinary skill in the art.

The term unit, as used herein, can have conventional meaning in the field of electronics, electrical devices and/or electronic devices and can include, for example, electrical and/or electronic circuitry, devices, modules, processors, memories, logic solid state and/or discrete devices, computer programs or instructions for carrying out respective tasks, procedures, computations, outputs, and/or displaying functions, and so on, as such as those that are described herein.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

As described herein, device and/or apparatus can be represented by a semiconductor chip, a chipset, or a (hardware) module comprising such chip or chipset; this, however, does not exclude the possibility that a functionality of a device or apparatus, instead of being hardware implemented, be implemented as a software module such as a computer program or a computer program product comprising executable software code portions for execution or being run on a processor. Furthermore, functionality of a device or apparatus can be implemented by any combination of hardware and software. A device or apparatus can also be regarded as an assembly of multiple devices and/or apparatuses, whether functionally in cooperation with or independently of each other. Moreover, devices and apparatuses can be implemented in a distributed fashion throughout a system, so long as the functionality of the device or apparatus is preserved. Such and similar principles are considered as known to a skilled person.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

In addition, certain terms used in the present disclosure, including the specification and drawings, can be used synonymously in certain instances (e.g., “data” and “information”). It should be understood, that although these terms (and/or other terms that can be synonymous to one another) can be used synonymously herein, there can be instances when such words can be intended to not be used synonymously.

Embodiments of the techniques and apparatus described herein also include, but are not limited to, the following enumerated examples:

A1. A method for a user equipment (UE) configured for positioning in a radio access network (RAN), the method comprising:
receiving, from a positioning node, a configuration of a plurality of positioning reference signal (PRS) resources, wherein:
   each PRS resource is associated with one of a plurality of different carrier frequencies or positioning frequency layers (PFLs) transmitted by a RAN node; and
   the configuration includes one or more aggregation identifiers indicating one or more relationships between the plurality of carrier frequencies or PFLs;
based on the one or more aggregation identifiers, determining which of the plurality of PRS resources can be aggregated for positioning measurements across two or more of the carrier frequencies or PFLs; and
based on the determination, performing positioning measurements using at least a portion of the configured PRS resources; and
sending, to the positioning node, a report including the positioning measurements.

A2. The method of embodiment A1, wherein when it is determined that PRS resources associated with two or more carrier frequencies of PFLs can be aggregated, the positioning measurements are performed jointly and/or coherently on the aggregated PRS resources.

A3. The method of any of embodiments A1-A2, wherein when it is determined that PRS resource can be aggregated across two or more carrier frequencies or PFLs, the UE uses a single receiver (Rx) chain to receive the PRS on which the positioning measurements are performed.

A4. The method of any of embodiments A1-A2, wherein:
the UE includes a plurality of receiver (Rx) chains arranged into a plurality of Rx timing error groups (TEGs) or phase coherence error groups (PEGs); and
when it is determined that PRS resource can be aggregated across two or more carrier frequencies or PFLs, the UE uses multiple Rx chains of a single TEG or PEG to receive the PRS on which the positioning measurements are performed.

A5. The method of embodiment A4, wherein:
determining which of the plurality of PRS resources can be aggregated comprises determining that the PRS resources cannot be aggregated when no two of the carrier frequencies or PFLs can be received by one of the following: a single UE receiver (Rx) chain, or multiple UE Rx chains that are in a single TEG or PEG; and
the positioning measurements are performed individually and/or separately on PRS resources of at least two carrier frequencies or PFLs.

A6. The method of any of embodiments A4-A5, wherein for each positioning measurement, the report includes an identifier of a TEG or a PEG associated with the Rx chain used to make the positioning measurement.

A7. The method of any of embodiments A1-A6, wherein:
each PFL includes one or more PRS resource sets, with each PRS resource set including one or more PRS resources; and
each aggregation identifier is associated with one of the following: a PFL, a PRS resource set, or a PRS resource.

A8. The method of any of embodiments A1-A7, further comprising receiving, from the RAN node, an association or mapping between the plurality of carrier frequencies or PFLs and one or more of the following used by the RAN node to transmit the PRS: a plurality of transmit (Tx) chains, and a plurality of antenna ports.

B1. A method for a positioning node configured to facilitate positioning of user equipment (UEs) operating in a radio access network (RAN), the method comprising:
sending, to a UE, a configuration of a plurality of positioning reference signal (PRS) resources, wherein:
   each PRS resource is associated with one of a plurality of different carrier frequencies or positioning frequency layers (PFLs) transmitted by a RAN node; and
   the configuration includes one or more aggregation identifiers indicating one or more relationships between the plurality of carrier frequencies or PFLs; and
receiving, from the UE, a report including positioning measurements performed by the UE on PRS resources associated with two or more of the carrier frequencies or PFLs.

B2. The method of embodiment B1, wherein the received positioning measurements are one of the following:
positioning measurements performed jointly and/or coherently on aggregated PRS resources, using a single UE receiver (Rx) chain;
positioning measurements performed jointly and/or coherently on aggregated PRS resources, using a multiple UE Rx chains that are associated with a common Rx timing error groups (TEG) or phase coherence error groups (PEG);
positioning measurements performed individually and/or separately on PRS resources of at least two carrier frequencies or PFLs.

B3. The method of embodiment B2, wherein for each positioning measurement, the report includes an identifier of a TEG or a PEG associated with the UE Rx chain used to make the positioning measurement.

B4. The method of any of embodiments B1-B3, further comprising receiving, from the RAN node, a configuration of PRS resources in which PRS are transmitted by the RAN node, wherein the configuration includes the one or more aggregation identifiers.

B5. The method of any of embodiments B1-B4, further comprising receiving, from the RAN node, an association or mapping between the plurality of carrier frequencies or PFLs and one or more of the following used by the RAN node to transmit the PRS: a plurality of transmit (Tx) chains, and a plurality of antenna ports.

B6. The method of any of embodiments B1-B5, wherein:
each PFL includes one or more PRS resource sets, with each PRS resource set including one or more PRS resources; and
each aggregation identifier is associated with one of the following: a PFL, a PRS resource set, or a PRS resource.

C1. A method for a radio access network (RAN) node configured to support positioning of user equipment (UEs) in the RAN, the method comprising:
sending, to a positioning node, a configuration of a plurality of positioning reference signal (PRS) resources in which PRS are transmitted by the RAN node, wherein:
   each PRS resource is associated with one of a plurality of different carrier frequencies or positioning frequency layers (PFLs); and
   the configuration includes one or more aggregation identifiers indicating one or more relationships between the plurality of carrier frequencies or PFLs;
and transmitting PRS in one or more cells according to the configuration.

C2. The method of embodiment C1, wherein:
the plurality of carrier frequencies or PFLs are transmitted using a plurality of transmit (Tx) chains, with each of the plurality of Tx chains handling at least one of the carrier frequencies or PFLs; and
the plurality of Tx chains are arranged into a plurality of Tx timing error groups (TEGs) or phase coherence error groups (PEGs), with each PEG or TEG include at a plurality of Tx chains.

C3. The method of any of embodiments C1-C2, further comprising sending, to the positioning node and/or to a UE, an association or mapping between the plurality of carrier frequencies or PFLs and one or more of the following used by the RAN node to transmit the PRS: a plurality of transmit (Tx) chains, and a plurality of antenna ports.

C4. The method of any of embodiments C1-C3, wherein:
each PFL includes one or more PRS resource sets, with each PRS resource set including one or more PRS resources; and
each aggregation identifier is associated with one of the following: a PFL, a PRS resource set, or a PRS resource.

D1. A user equipment (UE) configured for positioning in a radio access network (RAN), the UE comprising:
communication interface circuitry configured to communicate with one or more RAN nodes and with a positioning node associated with the RAN; and
processing circuitry operatively coupled to the radio transceiver circuitry, whereby the processing circuitry and the radio transceiver circuitry are configured to perform operations corresponding to any of the methods of embodiments A1-A7.

D2. A user equipment (UE) configured for positioning in a radio access network (RAN), the UE being further configured to perform operations corresponding to any of the methods of embodiments A1-A7.

D3. A non-transitory, computer-readable medium storing computer-executable instructions that, when executed by processing circuitry of a user equipment (UE) configured for positioning in a radio access network (RAN), configure the UE to perform operations corresponding to any of the methods of embodiments A1-A7.

D4. A computer program product comprising computer-executable instructions that, when executed by processing circuitry of a user equipment (UE) configured for positioning in a radio access network (RAN), configure the UE to perform operations corresponding to any of the methods of embodiments A1-A7.

E1. A positioning node configured to facilitate positioning of user equipment (UEs) operating in a radio access network (RAN), the positioning node comprising:
communication interface circuitry configured to communicate with UEs and with RAN nodes; and
processing circuitry operatively coupled to the communication interface circuitry, whereby the processing circuitry and the communication interface circuitry are configured to perform operations corresponding to any of the methods of embodiments B1-B6.

E2. A positioning node configured to facilitate positioning of user equipment (UEs) operating in a radio access network (RAN), the positioning node being further configured to perform operations corresponding to any of the methods of embodiments B1-B6.

E3. A non-transitory, computer-readable medium storing computer-executable instructions that, when executed by processing circuitry of a positioning node configured to facilitate positioning of user equipment (UEs) operating in a radio access network (RAN), configure the positioning node to perform operations corresponding to any of the methods of embodiments B1-B6.

E4. A computer program product comprising computer-executable instructions that, when executed by processing circuitry of a positioning node configured to facilitate positioning of user equipment (UEs) operating in a radio access network (RAN), configure the positioning node to perform operations corresponding to any of the methods of embodiments B1-B6.

F1. A radio access network (RAN) node configured to support positioning of user equipment (UEs) in the RAN, the RAN node comprising:
communication interface circuitry configured to communicate with UEs and with a positioning node associated with the RAN; and
processing circuitry operatively coupled to the communication interface circuitry, whereby the processing circuitry and the communication interface circuitry are configured to perform operations corresponding to any of the methods of embodiments C1-C4.

F2. A radio access network (RAN) node configured to support positioning of user equipment (UEs) in the RAN, the RAN node being further configured to perform operations corresponding to any of the methods of embodiments C1-C4.

F3. A non-transitory, computer-readable medium storing computer-executable instructions that, when executed by processing circuitry of a radio access network (RAN) node configured to support positioning of user equipment (UEs) in the RAN, configure the RAN node to perform operations corresponding to any of the methods of embodiments C1-C4.

F4. A computer program product comprising computer-executable instructions that, when executed by processing circuitry of a radio access network (RAN) node configured to support positioning of user equipment (UEs) in the RAN, configure the RAN node to perform operations corresponding to any of the methods of embodiments C1-C4.

1.-42. (canceled)

43. A method for a user equipment (UE) configured for positioning in a radio access network (RAN) the method comprising:
receiving from a positioning node a configuration of a plurality of positioning reference signal (PRS) resources, wherein:
each PRS resource is associated with one of a plurality of different carrier frequencies or positioning frequency layers (PFLs) transmitted by a RAN node; and
the configuration includes one or more aggregation identifiers indicating one or more relationships between the plurality of carrier frequencies or PFLs;
selectively performing positioning measurements jointly and/or coherently on PRS resources associated with two or more of the carrier frequencies or PFLs, based on one or more of the following: the one or more aggregation identifiers, and an arrangement of the UE's plurality of receiver (Rx) chains; and
sending to the positioning node a report including the positioning measurements.

44. The method of claim 43, wherein at least one of the aggregation identifiers indicates a transmit phase coherency between two or more of the carrier frequencies or PFLs.

45. The method of claim 43, wherein selectively performing positioning measurements jointly and/or coherently comprises:
based on the one or more aggregation identifiers, determining which of the plurality of PRS resources can be aggregated for joint and/or coherent positioning measurements;
when it is determined that PRS resources associated with two or more different carrier frequencies or PFLs can be aggregated, performing positioning measurements jointly and/or coherently on the PRS resources associated with the two or more different carrier frequencies or PFLs; and
when it is determined that no PRS resources associated with two or more different carrier frequencies or PFLs can be aggregated, performing positioning measurements individually and/or separately on PRS resources associated with the respective carrier frequencies or PFLs.

46. The method of claim 45, wherein the UE's plurality of Rx chains are arranged into a plurality of Rx timing error groups (TEGs) or Rx phase coherence error groups (PEGs).

47. The method of claim 46, wherein:
determining which of the plurality of PRS resources can be aggregated for joint and/or coherent positioning measurements is further based on which of the plurality of carrier frequencies or PFLs can be received by one of the following: a single Rx chain, or multiple Rx chains that are in a single Rx TEG or Rx PEG; and
performing positioning measurements jointly and/or coherently on the PRS resources associated with the two or more different carrier frequencies or PFLs comprises receiving the two or more different carrier frequencies or PFLs using one of the following: a single Rx chain, or multiple Rx chains that are in a single Rx TEG or Rx PEG.

48. The method of claim 46, wherein for each positioning measurement, the report includes an identifier of an Rx TEG or a Rx PEG associated with the Rx chain used to perform the positioning measurement.

49. The method of claim 43, wherein:
the plurality of PRS resources are arranged into one or more PRS resource sets, with each PRS resource set including one or more PRS resources; and
each aggregation identifier in the configuration is associated with a corresponding one of the following: PRS resource, or PRS resource set.

50. The method of claim 43, further comprising receiving from the RAN node an association or mapping between the plurality of carrier frequencies or PFLs and one or more of the following used by the RAN node to transmit the PRS: a plurality of transmit (Tx) chains, and a plurality of antenna ports.

51. The method of claim 43, wherein:
the plurality of carrier frequencies or PFLs are transmitted by the RAN node using a plurality of transmit (Tx) chains, with each of the plurality of Tx chains transmitting at least one of the carrier frequencies or PFLs;
the plurality of Tx chains are arranged in a plurality of Tx timing error groups (TEGs) or Tx phase coherence error groups (PEGs) with each Tx PEG or Tx TEG including more than one of the plurality of Tx chains; and
each aggregation identifier indicates two or more of the carrier frequencies or PFLs transmitted by one of the following: a single Tx chain, or multiple Tx chains in a single Tx PEG or Tx TEG.

52. A method for a positioning node configured to facilitate positioning of user equipment (UE)s, operating in a radio access network (RAN) the method comprising:
sending, to a UE having a plurality of receiver (Rx) chains, a configuration of a plurality of positioning reference signal (PRS) resources, wherein:
each PRS resource is associated with one of a plurality of different carrier frequencies or positioning frequency layers (PFLs) transmitted by a RAN node; and
the configuration includes one or more aggregation identifiers indicating one or more relationships between the plurality of carrier frequencies or PFLs; and
receiving from the UE a report including positioning measurements performed by the UE, using the plurality of Rx chains, on PRS resources associated with two or more of the carrier frequencies or PFLs.

53. The method of claim 52, wherein at least one of the aggregation identifiers indicates a transmit phase coherency between two or more of the carrier frequencies or PFLs.

54. The method of claim 52, wherein:
the UE's plurality of receiver (Rx) chains are arranged into a plurality of Rx timing error groups (TEGs) or Rx phase coherence error groups (PEGs); and
for each positioning measurement, the report includes an identifier of an Rx TEG or an Rx PEG associated with a UE Rx chain used to perform the positioning measurement.

55. The method of claim 54, wherein the received positioning measurements include one of the following:
positioning measurements performed by the UE jointly and/or coherently on PRS resources associated with two or more different carrier frequencies or PFLs, using one of the following: a single UE Rx chain, or multiple UE Rx chains in a single Rx TEG or Rx PEG; or
positioning measurements performed by the UE individually and/or separately on PRS resources associated with two or more different carrier frequencies or PFLs.

56. The method of claim 55, wherein:
the plurality of carrier frequencies or PFLs are transmitted by the RAN node using a plurality of transmit (Tx) chains, with each of the plurality of Tx chains transmitting at least one of the carrier frequencies or PFLs;
the plurality of Tx chains are arranged in a plurality of Tx timing error groups (TEGs) or Tx phase coherence error groups (PEGs) with each Tx PEG or Tx TEG including a plurality of Tx chains; and
each aggregation identifier indicates two or more of the carrier frequencies or PFLs transmitted by one of the following: a single Tx chain, or multiple Tx chains in a single Tx PEG or Tx TEG.

57. The method of claim 52, further comprising receiving from the RAN node an association or mapping between the plurality of carrier frequencies or PFLs and one or more of the following used by the RAN node to transmit the PRS: a plurality of transmit (Tx) chains, and a plurality of antenna ports.

58. The method of claim 52, wherein:
the plurality of PRS resources are arranged into one or more PRS resource sets, with each PRS resource set including one or more PRS resources; and
each aggregation identifier in the configuration is associated with a corresponding one of the following: PRS resource, or PRS resource set.

59. A method for a radio access network (RAN) node configured to support positioning of user equipment (UEs), in the RAN, the method comprising:
sending to a positioning node a configuration of a plurality of positioning reference signal (PRS) resources in which PRS are transmitted by the RAN node, wherein:
each PRS resource is associated with one of a plurality of different carrier frequencies or positioning frequency layers (PFLs); and
the configuration includes one or more aggregation identifiers indicating one or more relationships between the plurality of carrier frequencies or PFLs; and
transmitting PRS in one or more cells in accordance with the configuration, wherein the plurality of carrier frequencies or PFLs are transmitted using a plurality of transmit (Tx) chains, with each of the plurality of Tx chains transmitting at least one of the carrier frequencies or PFLs.

60. The method of claim 59, wherein at least one of the aggregation identifiers indicates a transmit phase coherency between two or more of the carrier frequencies or PFLs.

61. The method of claim 59, wherein:
the plurality of Tx chains are arranged in a plurality of Tx timing error groups (TEGs) or Tx phase coherence error groups (PEGs), with each Tx PEG or Tx TEG including a plurality of Tx chains; and
each aggregation identifier indicates two or more of the carrier frequencies or PFLs transmitted by one of the following: a single Tx chain, or multiple Tx chains in a single Tx PEG or Tx TEG.

62. The method of claim 59, wherein transmitting PRS in one or more cells in accordance with the configuration comprises transmitting in PRS resources associated with two or more different carrier frequencies or PFLs indicated by one of the aggregation identifiers, using one of the following: a single Tx chain, or multiple Tx chains that are phase coherent.

63. The method of claim 59, further comprising sending, to the positioning node and/or to a UE, an association or mapping between the plurality of carrier frequencies or PFLs and one or more of the following used by the RAN node to transmit the PRS: the plurality of Tx chains, and a plurality of antenna ports.

64. The method of claim 59, wherein:
the plurality of PRS resources are arranged into one or more PRS resource sets, with each PRS resource set including one or more PRS resources; and
each aggregation identifier is associated with a corresponding one of the following: PRS resource, or PRS resource set.

65. User equipment (UE) configured for positioning in a radio access network (RAN), the UE comprising:
communication interface circuitry configured to communicate with one or more RAN nodes and with a positioning node associated with the RAN; and
processing circuitry operatively coupled to the communication interface circuitry, wherein the processing circuitry and the communication interface circuitry are configured to perform the method of claim 43.

66. Positioning node configured to facilitate positioning of user equipment (UEs) operating in a radio access network (RAN), the positioning node comprising:
communication interface circuitry configured to communicate with UEs and with RAN nodes; and
processing circuitry operatively coupled to the communication interface circuitry, wherein the processing circuitry and the communication interface circuitry are configured to perform the method of claim 52.

67. Radio access network (RAN) node configured to support positioning of user equipment (UEs) in the RAN, the RAN node comprising:
communication interface circuitry configured to communicate with UEs and with a positioning node associated with the RAN; and
processing circuitry operatively coupled to the communication interface circuitry, wherein the processing circuitry and the communication interface circuitry are configured to perform the method of claim 59.
